(19) United States
(12) Patent Application Publication
(10) Pub. No.: US 2022/0270190 A1
(43) Pub. Date: Aug. 25, 2022

(54) SYSTEMS AND METHODS OF SCALING FACILITY TECHNOLOGY ADOPTION

(71) Applicant: Retrolux, LLC, Boise, ID (US)

(72) Inventor: Leif Eric Elgethun, Boise, ID (US)

(21) Appl. No.: 17/652,023

(22) Filed: Feb. 22, 2022

Related U.S. Application Data
(60) Provisional application No. 63/151,559, filed on Feb. 19, 2021.

(51) Int. Cl. G06Q 50/16; G06Q 10/06

(52) U.S. Cl. CPC G06Q 50/163; G06Q 10/06313

(57) ABSTRACT

Systems and methods of facility management, and more specifically scaling facility technology adoption, are disclosed wherein data related to a facility are acquired from a plurality of sources, a proposal is generated related to maintaining, upgrading, modifying, etc. the facility and presented to an appropriate decisionmaker. The data underlying proposal comprises historical data, operational data, climate data, installed facility items data, candidate facility items, financial data related to operation, maintenance, etc. Early or rapid adoption of new technology is promoted and/or otherwise facilitated. A service is provided to the facility, and the facility purchases at least a portion of the service as a service-as-a-commodity. The service-as-a-commodity may be exchanged to another facility, or redeemed against providing the service. Purchase, exchange, and redemption of the service-as-a-commodity is managed by use of a pack chain, and may be recorded to a blockchain.

### RELATED APPLICATIONS

The present application claims the benefit of priority under 35 U.S.C. Section 119(e) of U.S. Provisional Patent Application No. 63/151,559 entitled SYSTEMS AND METHODS OF Scaling FACILITY TECHNOLOGY ADOPTION, filed Feb. 19, 2021, which is hereby incorporated herein by reference in its entirety.

### TECHNICAL FIELD

The present disclosure relates generally to the field of building and facility management systems and methods. More specifically, the present disclosure relates to management systems and methods directed toward replacing, upgrading, and otherwise managing elements of a building or other facility.

### BACKGROUND

Buildings and other facilities are constructed with components existent at the time of construction. Components, such as those associated with lighting, heating, air conditioning, ventilation, plumbing etc., of a building or a facility over time may become outdated, may fail, or may otherwise become in need of maintenance or replacement. Similarly, cost of operation of such components may increase over time due to age of the components or infrastructure of the building or facility. Additionally, a building or a facility typically draws upon services, e.g., electrical power, having costs that may vary over time, or cyclically over time. Such costs, or, more particularly, variability and/or volatility of such costs may introduce uncertainty in the profitability, sustainability, etc., of the building or facility. Certain embodiments of the present disclosure can address one or more of the foregoing issues.

### SUMMARY

The present disclosure provides systems and methods to monitor and/or inform (e.g., a building and/or facility owner or manager, service providers, vendors) about a current status of components of a building/facility, and cost management of services consumed by the building/facility, which may comprise acquisition, exchange, and disposition of a service as a commodity.

### BRIEF DESCRIPTION OF THE DRAWINGS

The present embodiments will become more fully apparent from the following description and appended claims, taken in conjunction with the accompanying drawings. Understanding that the accompanying drawings depict only a typical embodiment and are, therefore, not to be considered limiting of the scope of the disclosure, the embodiments will be described and explained with specificity and detail in reference to the following accompanying drawings.

FIG. 1A is a relational diagram of a facility management system, according to an embodiment of the present disclosure.

FIG. 1B is a more detailed relational diagram of the facility management system of FIG. 1A.

FIG. 2 is relational diagram of the UMS of FIGS. 1A and 1B, wherein the computing system provides UMS service to a plurality of buildings/facilities, according to an embodiment of the present disclosure.

FIG. 3 is a relational diagram of the UMS of FIGS. 1A and 1B, wherein the building is both a consumer of a service and a producer of the service, according to an embodiment of the present disclosure.

FIG. 4 is a relational diagram of a UMS and a second UMS, wherein both UMSs are similar to the UMS of FIGS. 1A-3 in at least some respects, according to an embodiment of the present disclosure.

FIG. 5 is a flowchart illustrating a method of operation for the facility management system of FIGS. 1A and 1B, according to an embodiment of the present disclosure.

FIG. 6 is a flowchart further illustrating the method of operation for the facility management system of FIGS. 1A-3, according to an embodiment of the present disclosure.

FIG. 7 is a flowchart illustrating a method of a UMS, such as the UMSs of FIGS. 1A-6, for handling a service as a commodity, according to an embodiment of the present disclosure.

### DETAILED DESCRIPTION

A facility can be a complex combination of components and sets of components (or systems) that require ongoing maintenance and upkeep to perform well and/or efficiently. Presently, the manner that facilities managers maintain facilities is a rather linear process that involves recognizing a potential facility project (e.g., a replacement or upgrade), requesting or otherwise receiving proposals, and using mostly ad hoc judgment to accept a proposal.

Currently, building and/or facility owners and/or managers can prospectively identify a potential facility project through reliance on information provided by a component manufacturer, when the component was installed or originally designed, and an estimated end of life. Such information, especially of the latter sort, may not reflect real-world operation, durability, life expectancy, etc., of the component. Presently available building/facility management software solutions may provide tools to track manufacturer data and guestimate life expectancy and optimal maintenance. However, these tools lack ability to provide actual operational status and lack perspective in the way of a cost benefit analysis or estimated return on investment. Accordingly, a more common and perhaps de facto manner by which building/facility owner or manager may become aware of a need to maintain, replace, or update a component is when the component fails or is about to fail. Another way potential facility projects are identified is when a vendor or supplier raises awareness of a component's potential problem, etc., such as through sales visits, marketing, and referrals to facility managers, all of which consume lengths of time.

Once a building/facility owner or manager is aware of a facility project need, a replacement component may be identified by, for example, simply replacing the old component with an identical-but-new component, or a more recent variant of the same component. A building/facility owner or manager may be unaware of upgrade possibilities, including the availability of any upgrade components, and also an effect of an upgrade on operating expense (and, hence, a return-on-investment (“ROI”)). Even a building/facility owner or manager who seeks to maximize the ROI may learn of potential upgrade components only by word of mouth (as from other building/facility owners or managers, or vendors). Even searching through publicly available information, such as on the Internet, is unlikely to inform the building/facility owner or manager of all available components and, perhaps more importantly, the suitability of upgrade components for the particular building/facility and risk tolerance of the building/facility owner or manager. Once a building/facility owner or manager elects to replace or upgrade a component (or system of related components), current technology does not provide a ready means for managing the selection of components, installers or contractors, compliance, provisioning of selected components, and updating appropriately any building/facility managements system. Furthermore, a system does not exist which may monitor the real-world performance of the installed replacement or upgrade components in the particular building/facility so that realization of the expected ROI, and other metrics, can be ascertained, future replacement/upgrade programs may be planned and implemented, and aggregated performance can be used to anonymously (or otherwise) inform a decision regarding replacement or upgrade of similar such components in other buildings/facilities. In view of the foregoing issues and challenges, there may be notable desirability for systems and methods to better manage facilities.

Similarly, a building/facility may consume (or otherwise use) a service or resource. The amount of a service or resource used by a building/facility may vary for a number of reasons, such as, for example, progressive wear of a component, failure of a component, seasonal demand due to weather, or holiday, etc. Just as a building/facility may forecast demand for an expendable commodity (e.g., cleaning supplies), and acquire a cost-effective stock of the commodity, a building/facility may similarly benefit from forecasting demand for a service or resource and pre-purchasing a provision of the service or resource in a cost-effective manner.

As used herein, the term “structure” refers to any constructed or manmade structure having a generally fixed geolocation, and physical dimensions. Examples of a structure include, but are not limited to, a building (e.g., an office complex, a business center, a single family home, a single unit of or set of units of or an entire multi-unit residential structure (e.g., apartment, townhouse condo), an emergency/medical services structure (e.g., firehouse, police station, hospital, etc.)), a recreational structure (e.g., park. urban trail or trail system, skating rink, skate park, ball park, soccer field other sporting event structure, etc.), an entertainment structure (e.g., theater, professional sports arena, amphitheater etc.), a shopping structure (e.g., retail sales building, “big box” retail building, strip mall, mall, etc.), a transportation structure (e.g., urban transit centers, bus stations, train stations, railways, airports, harbors, bridges, etc.), a communication structure (e.g., network routing center, radio tower, cell tower, etc.), a farming structure, an irrigation structure (e.g., a canal, etc.), an energy structure (e.g., transmission station, powerplant, dam, substation, nuclear reactor, etc.). For convenience of the disclosure, any erected or manmade “structure” can be encompassed within the description of and considered a structure, as the term is used herein.

A facility may comprise a single structure, such as a building. A facility may comprise a set of structures. A facility may comprise a site (a location, such as a plot of land) on which a structure (or set of structures) may be erected. A facility may also comprise equipment installed or situated on a site of a structure and/or otherwise used in conjunction with a structure (e.g. heating, ventilation, and air conditioning equipment, machinery, forklifts, service vehicles, etc.). A complex facility can comprise a site (e.g., the land), one or more structures, and equipment associated with the land and/or structures.

As used herein, the term “facility item” refers to a component that may be installed to a facility, and is sufficiently broad to encompass things as simple or small as, for example, an attachment device (e.g., a screw, a bolt, a hanger, etc.) and things as complex as a “system” (e.g., ventilation system). The term “component” may be used in the present disclosure to represent a “facility item” such that the two terms are interchangeably used.

As used herein, the term “schedule” refers to a temporal arrangement of events, such as by time and date, or by sequential order of events with or without a particular time reference.

As used herein, the terms “service-as-a-commodity” and “service-as-commodity” refers to any consumable service, e.g., electrical power, computing power, etc., which may be bought and sold, and, more particularly, wherein the service may be purchased in advance, and may be subsequently used, exchanged, sold, or otherwise disposed of.

As used herein, the term “blockchain” refers to blockchain technology in the ordinary sense of the word with the relevant art.

As used herein, the term “data pack” refers to an ordered arrangement of electronic data coupled together in an electronic assemblage, the electronic assemblage having a checksum based on the electronic data whereby any alteration to the electronic data after the data pack is assembled would yield a different checksum. A block of a blockchain is one example of a data pack.

As used herein, the term “pack chain” refers to an ordered collection of data packs wherein each data pack is peer-verified before acceptance for inclusion in the pack chain, and wherein the pack chain is peer-verified to prevent or identify any alteration to the pack chain, e.g., a change to a data pack, an omission of a data pack, an insertion of non-peer-reviewed data pack, etc. In some respects, a pack chain is similar to a blockchain.

As used herein, the term “electronic token” (“token”) refers to particular data representing at least: a particular consumable service or product, a particular quantum of the consumable service or product, an inception time and date of the particular quantum of the consumable service or product, and an ownership of the particular quantum of the consumable service or product.

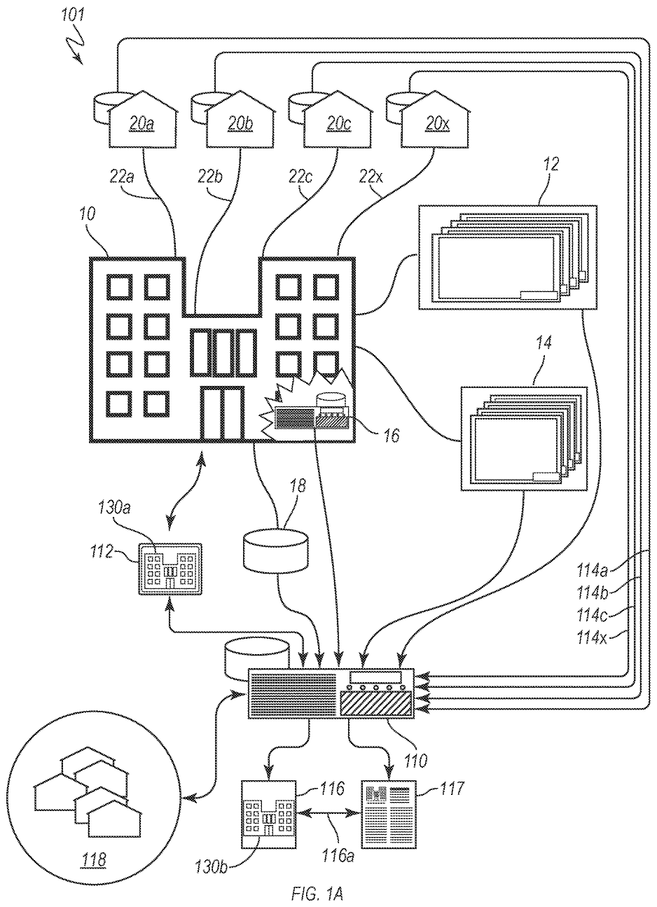

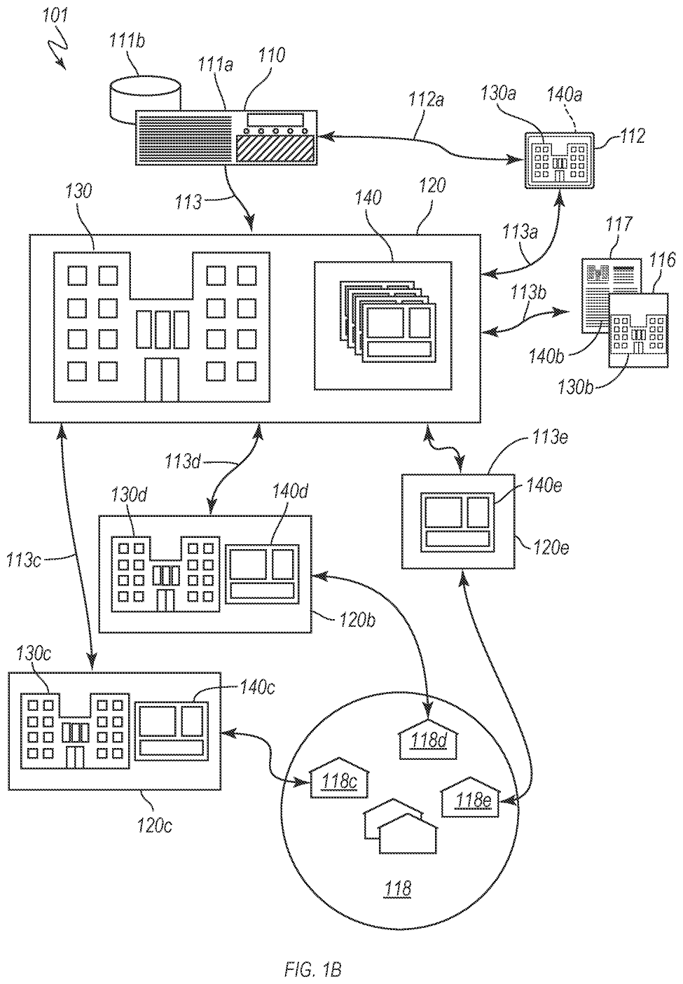

FIG. 1A is a relational diagram for a facility management system 101, according to an embodiment of the present disclosure. The facility management system 101, may, in some embodiments, be thought of or primarily utilized to manage upgrades to a facility, which may be one of many advantages of the embodiments of the present disclosure over existing building management systems (“BMS”), which are also sometimes known as facility management systems (according to technology available prior to the present disclosure). For sake of clarity, and to differentiate from previously available or existing facility management systems, the embodiment of a facility management system 101 is referred to at times in the description herein as an upgrade management system (“UMS”) 101. Though the description refers to an upgrade management system or UMS, this term is intended to refer to facility management systems according to the present disclosure and capable of any (and potentially all) functionality described herein and is not limited to upgrades. Accordingly, reference to and description of the UMS 101 pertains to a facility management system according to an embodiment of the present disclosure.

The UMS 101 may aid in recognition of facility projects that can improve facility maintenance, efficiency, and/or operation and that can more expeditiously and efficiently introduce new technologies into a facility. The UMS 101 can speed market adoption of new technologies by identifying facilities that can take advantage of new technology, presenting high ROI proposals and supportable and accurate insight of these ROIs, and facilitating installation of technology of accepted proposals, and monitoring operational performance of installed technology. Data gathered in this cyclical (rather than linear) process can be used to improve future identification of facility projects and proposals for the same.

A building 10 is shown in FIG. 1A and building 10 may represent any facility, whether a structure, a site, equipment (in conjunction with the structure and/or site), and any combination thereof. For convenience, the disclosure addresses the facility as the building 10; however, the disclosure anticipates that any aspect of a facility is encompassed by the disclosure. For example, the building 10 may represent multiple structures of a facility, and may further encompass equipment positioned on the site of the facility which may be external to a structure.

The building 10 may have been constructed according to a set of build plans 12. The build plans 12 may be obtained or otherwise received by the UMS 101 and may include map data of the building 10. The map data may include plan data providing a layout of the facility and relevant item data that provides one or more facility items, including a location of each facility item within the layout of the facility.

In the present example of FIG. 1A, the building 10 may have undergone one or more renovations, upgrades, retrofits, etc., which may have been conducted according to one or more sets of update plans 14. The update plans 14 may also be obtained or otherwise received by the UMS 101 and may comprise additional map data, including plan data providing any updates to the layout of the facility and additional relevant item data that may provide any updates to the one or more facility items, including a location of each facility item within the layout of the facility.

The building 10 may be managed using and/or with aid of a BMS 16 (which may alternatively or in addition be known a facility management system according to technology available prior to the present disclosure). The BMS 16 is shown in a cutaway of the building 10 for convenience of the disclosure and not by way of limitation. The BMS 16 may collect and provide BMS data to the UMS 101. The BMS data can include operational data (e.g., historical operational data providing historical operating conditions of the building 10 and/or current operational data providing current operating conditions of the building 10).

In addition to the build plans 12, upgrade plans 14, BMS 16 data, an other information source 18 may also be available, wherein data regarding the building 10 may be found. The other information source 18 may be a single source of information, or may comprise multiple sources of information. Examples, without limitation, of the other information source 18 may include a land survey, electronic map data (e.g., Google Maps™ mapping service), a photographic survey, an architectural article, court records, etc.

Where feasible, the UMS 101 may aggregate information regarding the building 10 from one or more of the build plans 12, the update plans 14, the BMS 16, and the other information source 18. More particularly, a facility management computing system 110 of the UMS 101 may acquire information regarding the building 10 from one or more of the build plans 12, the update plans 14, the BMS 16, and the other information source 18. As noted above, the information regarding the building 10 may include map data and operational data (historical operational data and live or present operational data). The map data and operational data may be converted into a digital representation of the building 10, as will be explained in greater detail below.

The building 10 may receive or consume services from one or more service providers 20a-20x. By way of non-limiting example, a first service provider 20a may supply electrical power to the building 10; a second service provider 20b may supply heating, ventilation, air conditioning (“HVAC”) service to the building 10; and a third service provider 20c may supply water to the building 10. Other services are also anticipated by the present disclosure, such as, e.g., network services, computing services, etc. Furthermore, in some embodiments, the building 10 may be supplied with a single service from multiple service providers 20a-20x. In one embodiment, the computing system 110 may acquire data regarding consumption of services from the service providers 20a-20x. For example, the first service provider 20a may provide (e.g., sell or otherwise deliver) 114a electrical consumption data about the building 10 to the computing system 110. Each service provider 20a-20x may provide 114a-114x to the computing system 110 data regarding consumption of the particular service by the building 10. Additionally, as discussed elsewhere herein, the building 10 may produce a consumable service, e.g., electrical power. If the building 10 produces more of the consumable service than is consumed at the building 10, the building 10 may deliver the excess to an appropriate service provider 20a-20x. The computing system 110 may likewise acquire and employ data regarding delivery of the excess consumable service, e.g., in offset calculation, commodity exchange, etc.

The UMS 101 may provide or otherwise employ a facility survey, which may be accomplished via a tablet computer 112 (hereafter, “tablet 112”) mobile smartphone, laptop, or other mobile computing device. The tablet 112 may be a portable, handheld computing device such as, e.g., an Apple iPad®, Samsung Galaxy Tab®, or the like. During the facility survey, information regarding the building 10 may be compiled with the tablet 112. The information regarding the building 10 may include map data, and more particularly item data, which may include information about facility items or components and may include one or more of a location within the facility of each component, a manufacturer and/or a model of each component, a number (e.g., a quantity) of each component, a condition of each component, service notes (such as how to access a component), etc. For example, without limitation, the facility survey may observe, and record to the tablet 112, the presence of each lighting system troffer in an area of the building; the manufacturer and model of each troffer; tubes, bulbs, arrays, etc. (including manufacturer and model information) installed to each troffer; physical condition (functioning, non-functioning, partially functioning, damaged, etc.) of each troffer and of each installed tube, bulb, array, etc.; and information on how to access a particular troffer if such would not be readily apparent, etc. The tablet 112 may communicatively connect (e.g., over the Internet or via wireless protocol) to the computing system 110 whereby data collected via the facility survey may be uploaded to the computing system 110. The data collected via the facility survey may be used by the UMS 101 to update a digital representation of the facility. The update of the digital representation may update any one or more of a layout of the facility, facility item data, and present operating conditions of the facility.

A non-limiting example pertaining to a lighting system of the building 10 can further explain the interrelations in the diagram of FIG. 1A. The first service provider 20a may provide electrical power to the building 10. The building 10 may comprise or have associated to it a system of electrically-powered lighting, one or more computing systems, one or more computer networking systems, and other equipment that consumes electricity. The first service provider 20a may accumulate electrical power consumption data that is related (or relatable) to, for example, the electrically-powered lighting system of the building 10. The computing system 110 may acquire or otherwise receive 114a the electrical power consumption data from the first service provider 20a. The computing system 110 may employ data from the tablet 112 acquired during the facility survey, and may further receive relevant item data for the lighting system from the build plans 12, the update plans 14, the BMS 16, and/or other information source 18. Each of these may comprise relevant item data pertaining to or regarding the specifications of the lighting system of the building 10. Lighting system specifications may include details such as identification of particular lighting components of the building 10. Identification of particular lighting components may include information such as mean time before failure (“MTBF”) provided by a manufacturer of the particular lighting component. If the information obtained from the build plans 12, update plans 14, BMS 16, and other information source 18 does not include MTBF, the UMS 101 may obtain MTBF data from one or more of a plurality of contractors and vendors 118. Furthermore, the update plans 14, the BMS 6, or other information source 18 may provide information relating to actual time between failures (“ATBF”) for the particular lighting component as installed and used at the building 10. As further explained below, the UMS 101 may use relevant item data from the build plans 12, update plans 14, BMS 16, and other information source 18, along with actual power consumption data provided by the first service provider 20a and related/relatable to the lighting system of the building, along with MTBF and/or ATBF to create, update, or otherwise maintain a digital representation of the facility and forecast a future failure of a particular lighting component or plurality of lighting components. The future failure forecast, in turn, may serve to provide guidance in the form of a proposal comprising at least one recommendation, or a proposal comprising a set of one or more recommendations, regarding, improving, maintaining, replacing, upgrading, retrofitting, modifying, etc. of lighting system components. The digital representation of the facility and/or the recommendation may be useful to one or more of a facility manager, a decision-maker, a vendor sales-rep, or the like. Such digital representation and/or recommendation may be provided (e.g., incorporated into a prospectus 116) to assist with regard to an action to be implemented in relation to one or more facility items and/or the lighting system (or other systems) of the building 10. In other words, a prospectus 116 provided by the UMS 101 may comprise one or more of a digital representation 130c of the building 10 and a proposal comprising a set of one or more recommendations, each recommendation comprising an action to be implemented in relation to the one or more corresponding facility items and a value proposition for implementing the action. The prospectus 116 may permit a user to explore 116a detailed information 117 related to the proposal, and to do so in varying degrees of detail. The digital representation and proposal are each discussed in greater detail below.

FIG. 1B is a more detailed relational diagram of the UMS 101 of FIG. 1A. The UMS 101 includes a computing system 110 that receives data pertaining to a facility and generates and maintains one or more data structure 120 pertaining to the facility.

The computing system 110 comprises a computer 111a capable of reading and executing machine-executable instructions. The computer 111a may be a general purpose computer or server, or a plurality of such computers or servers (e.g., such as in a distributed computing environment, cloud computing environment, etc.). The computing system 110 comprises a communication network interface to communicate over a network with a facility and with various portions of the UMS 101. The computing system 110 further comprises a memory (e.g., a storage system) 111b. The storage system 111b comprises at least one non-transitory memory, such as a hard disk drive, a solid-state disk drive, a flash memory, an EPROM, an EEPROM, an optical disk drive, or other memory known in the art. The non-transitory memory is capable of storing machine readable and executable instructions, which may be in the form of a software application, a collection of related software applications, application programming interfaces (APIs), software modules, etc., as is known in the art. The storage system 111b may comprise multiple memories. The storage system 111b may be physically internal to the computer 111a in one embodiment. In one embodiment, the storage system 111b may be externally located to the computer 111a. In one embodiment, the storage system 111b may comprise a plurality of storage subsystems wherein one or more storage subsystems may be internal or external to the computer 111a. In one embodiment, the storage system 111b may be remote to the computer 111a, or may comprise a storage subsystem that is remote to the computer 111a. The computing system 110 further comprises one or more processors capable of executing the machine executable instructions, and in electrical communication with the storage system 111b and to receive and transmit data via the communication interface. Execution of the machine executable instructions by the one or more processors may cause the one or more processors to perform operations to enhance facility management as described herein.

By way of non-limiting example, the machine-executable instructions stored at the storage 111b may comprise one or more software applications. Such a software application may constitute (or generate) a “smart contract,” the smart contract comprising contractual terms that may be executed to some extent at the computing system 110, or which may bind one or more parties to (a) particular performance(s), exchange(s), etc. In other words, a software application of the present disclosure may formulate a software module comprising machine-executable code that represents or causes a particular execution (e.g., creates an electronic order for an item or service, causes or affects an accounting entry, generates an exchange token (further described elsewhere herein), etc.) at the computing system 110 and may further obligate a vendor, a seller, a buyer, a facility owner/operator, etc., to perform a particular action or perfect an exchange (e.g., to deliver an item, to install an item, to provide a payment, etc.)

The computing system 110, using data acquired from one or more of build plans, update plans, BMS, other information source (see the build plans 12, the update plans 14, the BMS 16, the other information source 18 in FIG. 1A), and from the site survey performed with or via the tablet 112, transforms 113 the acquired data about the building (see the building 10 in FIG. 1A) into new data and a new data structure 120 (or a revised data structure). The new data structure 120 can include two types of logical organization. A first logical organization may constitute a logical or digital representation (hereafter, “digital twin”) 130 of the building 10. A second logical organization may constitute a relational data structure (RDS) 140 or document oriented database (DOC) containing data about systems, subsystems, components, etc., that are currently installed, or which may be candidates for installation at the building 10, financial data, build/component technical information (e.g., specifications), proposed installation schedules, and more. The new data structure 120 can also be an electronic prospectus 116, which may alternately or further comprise one or more proposals each including one or more recommendations pertaining to one or more corresponding facility items.

The computing system 110 receives, processes, and transforms data pertaining to a facility to generate and maintain the digital twin of a facility and to generate recommendations for the facility. The computing system 110 may include various components, engines, modules, or the like to accomplish various functions. For example, the computing system 110 may comprise a digital representation generation engine (hereafter, digital twin generation engine or “DTGE”) to generate the digital twin 130, and a digital representation operation engine (hereafter, the digital twin operation engine or “DTOE”) to facilitate updating the digital twin 130 and the RDS 140. The DTGE and the DTOE and any other components, engines, and/or modules of the computing system 110 may each comprise hardware and hardware logic at the computing system 110 and machine-readable and executable instructions by which data are parsed and processed to generate and update the digital twin 130. The digital twin 130 comprises a digital representation of the facility. An objective of the generation and updating of the digital twin is to provide an accurate, nearly accurate, or relevantly accurate digital representation of the facility. The digital twin is relevantly accurate when the components and/or systems relevant to a present consideration (e.g., a proposal, an analysis, a report, a presentation) are present. For example, if a proposal is directed to a lighting system, or if a report on operation of the facility is focused on a lighting system, then the digital twin is relevantly accurate if the lighting system facility items of the digital twin are complete, current, and accurate, notwithstanding information pertaining to the plumbing may be outdated or incomplete.

The computing system 110 (e.g., a DTGE of the computing system 110), may receive map data of a facility (such as the building 10) to generate the digital twin 130. The map data can include plan data providing a layout of the facility and relevant item data that provides facility items, including a location of each facility item within the layout of the facility. The layout may comprise a floor plan of the building 10 and/or a reflected ceiling plan of the building 10. The layout may comprise a site plan for the site where the building 10 is located. The computing system 110 may be further configured to receive historical operational data providing historical operating conditions of the facility, including the one or more facility items. The operating conditions of the facility may include one of an actual operational cost of facility operation and data from which the actual operational cost of facility operation can be derived. The computing system 110 may convert the map data and historical operational data into the digital twin 130 of the facility. In some embodiments, the computing system 110 may also be configured to transform the digital representation of the facility into a design stage digital model of the facility (e.g., a building information modelling (BIM) asset). In some embodiments, the digital representation comprises a design stage digital model, such as a BIM asset.

The computing system 110 (e.g., a DTOE of the computing system 110) may be configured to receive live operational data (or present operational data) providing present operating conditions of the facility. Furthermore, the computing system 110 may update the digital twin 130 with the present operating conditions of the building 10 to ensure the digital twin 130 continues to accurately represent the facility. The computing system 110 may provide a visualization of the building 10 to a computing device of a user to present to the user the layout of the building 10, one or more facility items of the building 10, and operating conditions of the building 10. For example, the computing system 110 may provide the visualization of the building to the tablet 112. The visual representation may be rendered as a two-dimensional (2D) representation or a three-dimensional (3D) representation.

The digital twin 130 may be generated by the computing system 110 from data acquired from the sources detailed above. The digital twin 130 may constitute a logical representation of the building 10 and may be capable of rendering to a display of a computing device (or being rendered on a display of a computing device as) an image of the building 10. For example, the digital twin 130 may be used to render a visualization of the building 10 on the tablet 112. The rendering of the building 10 may take the form of line drawings, architectural-style drawings, or other visual representation. The digital twin 130 may comprise one or more photographs and/or videos of the building 10, portions of the building 10, systems, subsystems, and components of the building 10, etc. The digital twin 110 may be capable of rendering a navigable interface. The navigable interface may comprise a menu to permit a user to select from a plurality of views of the digital twin 110, such as, e.g., a front elevation, a side elevation, a back elevation, a floor plan of a floor, a perspective view, an orthogonal view, etc., and wherein each such view may represent the building 10 or a user-selected portion of the building 10. The navigable interface may permit a user select a view incorporating a system or subsystem of the building 10. The navigable interface may permit a user to zoom in or out to view more detailed information, less detailed information, information of varying types, etc.

By way of example without limitation, the digital twin 130 may permit a user to view a front elevation representing the building 10. The user may select to view a line drawing. The user may select to view the front elevation in line drawing along with, for example, HVAC ducts. The user may select to view a floor plan of a particular floor, along with, for example, lighting troffers employed on the particular floor. The user may zoom in to obtain details regarding each troffer, or zoom out to view aggregate data regarding a plurality (or all) of the troffers for the particular floor. The digital twin 130 may permit the user to toggle between currently installed components and candidate components for installation. The user may, for example, select a particular troffer and view a photograph of the troffer that may have been taken during a facility survey. A view of a particular troffer may also display electrical load information for the particular troffer. Another view may display wiring used in the troffer, or proposed wiring. Another view may display conduits, tray routing, tray loading, wire detail, electrical loads, and more. The digital twin 130 may permit a user to conduct a logical “walk through” of the digital twin 130, displaying various renderings as the user “moves” through the digital twin 130, which may comprise line renderings, photographs, videos, technical data (for currently installed components or candidates for installation), and more.

The RDS 140 may be generated by the computing system 110 using information acquired from various sources as detailed above. The RDS 140, as its name suggests, may comprise at least one relational data structure. More particularly, the RDS 140 may comprise a plurality of tables. Each table may be linked to one or more other tables at one or more of the table level, a row level, a column level, an array level, or a cell level. In addition to data, the RDS 140 may comprise information to control rendering of data to a display (or printing) in a viewer usable manner. The RDS 140 may comprise: data about the building 10 itself as a whole, such as dimensions and materials of the building 10; data about systems and subsystems at the building 10, such as, e.g., electrical systems for lighting, computing, telephony, networking, etc.; data about components of the facility, including components of systems and subsystems, such as, e.g., lighting installations (for example, troffers, pans, headers, floor lights, signage, etc.) and components installed to lighting installations, potentially with technical specifications of the components, etc. Furthermore, the RDS 140 data may comprise time-related information, such as build dates, renovations dates, ages of systems, components, etc., MTBF/ATBF information for installed systems and components, MTBF and estimated ATBF information for candidates for installation to the building, etc. Additionally, the RDS 140 data may comprise financial information related to historical operation of the building 10, and, more particularly, to the use and maintenance of currently installed systems and components, and forward-looking estimates regarding replacement of current system and components or upgrade to new systems and/or components, including estimated costs of continued operation in an as-is condition, and costs of renovation, upgrade, etc., along with forecasts related to ROIs. The RDS 140 data may further comprise information regarding asset exchange values, such as, e.g., block purchase and exchange of electrical power, potentially as a quasi-currency. Furthermore, the RDS 140 may include data and other elements that do not strictly conform to the relational data model commonly known in computer database management. For example, the RDS 140 may include documents, as in a document store, and the RDS 140 may be configured to enable display or print of such documents.

A user of the digital twin 130 and/or the RDS 140 may be able to toggle between the digital twin 130 and the RDS 140. In one embodiment, the UMS 101 may permit rendering of at least a portion of the digital twin 130 simultaneously with some data from the RDS 140. By way of example without limitation, a user may be viewing the digital twin 130 and may select to view a rendering of the digital twin 130 with the current workspace lighting system. The user may select the current workspace lighting system and select to view financial data related to the workspace lighting system. The financial data may be a portion of the data of the RDS 140. The financial data may comprise historical cost of operation in aggregate, or based on a time period, or based on a physical portion of the building 10, etc. The user may toggle a view from visualization of the digital twin 130 to the financial data for the particular workspace lighting system as found in the RDS 140, and may also toggle back to the visualization of the digital twin 130. In one embodiment, the financial data from the RDS 140 may be displayable alongside the rendering of the digital twin 130. A user may also choose to toggle between a current installation to a proposed installation within the digital twin 130. Likewise, a user may toggle from financial data regarding a current installation to financial data regarding a proposed installation.

The UMS 101 may be configured to generate a single proposed installation or a plurality of proposed installations. Using the digital twin 130, a user may toggle between renderings of the current installation, between a particular rendering of the current installation and related rendering of a proposed installation, between various renderings of a proposed installation, and between renderings of various proposed installations. Furthermore, a user may toggle between various schedules of systems, subsystems, components of the current installation, or any generated proposed installation within the RDS 140. Similarly, a user may toggle between financial data of the current installation and that of any proposed installation within the RDS 140. The UMS 101 may also generate proposed installation schedules to assist in orderly execution of an installation or series of installations.

As previously discussed, a facility survey may be completed by a user using the tablet 112. The tablet 112 may communicate 112a with the computing system 110 to upload the facility survey (and particularly the data collected thereby) to the computing system 110.

The computing system 110 may also communicate 112a with the tablet 112 to download the data structure 120 generated by the UMS 101. More particularly a child digital twin 130a based on the digital twin 130, and a child RDS 140a based on the RDS 140 may be communicated 113a to the tablet 112. The tablet 112 may be configured to capture input from a user related to the child digital twin 130a and the child RDS 140a, and to communicate 113a the input to the respective parent digital twin 130 and RDS 140. The data structure 120 within the computing system 110 may be a complete data structure 120 that may be downloaded to the tablet 112 and utilized by the tablet 112 in absence of a communication link with the computing system 110, such as for collecting additional data pertaining to the facility (e.g., via a facility survey), providing accurate information about a facility to a user, and rendering a digital, three-dimensional (3D) visualization of the facility.

A prospectus 116 is generated by the UMS 101 in conjunction with the generating the new data structure 120. The computing system 110 of the UMS 101 may include a proposal engine to generate a proposal for the building 10. The proposal may comprise one or more recommendations each pertaining to one or more corresponding facility items. Each recommendation may comprise an action to be performed with respect to the one or more facility items in implementing the proposal. The recommendation may comprise one or more of improving, upgrading, replacing, retrofitting, modifying, and maintaining the facility item to which the recommendation pertains. An action may comprise doing nothing (potentially because the component or facility item is performing nominally, within an optimal or desired state, etc.). The computing system may be further configured to include in the proposal a value proposition for each recommended action of the proposal. The computing system 110 may be configured to compare the actual operational cost of facility operation to the value proposition for implementing the corresponding action. The computing system 110 may be configured to transmit the proposal to a point of contact for the building 10, such as an appropriate decisionmaker. The computing system 110 may generate a subsequent proposal based in part on information from the comparing the actual operational cost of facility operation to the value proposition for implementing the action to improve a recommendation (which may include a value proposition for implementing an action) in the subsequent proposal. One or more statistical or other algorithmic based methods may be used to evaluate the relevance, accuracy, and/or precision of the comparison, including artificial intelligence and/or machine learning algorithms. A neural network may be utilized in the comparison process and the neural network may be modified or enhanced based on the outcome of the comparison. The computing system 110 may transmit a report to the point of contact (e.g., via an update to the prospectus 116, or separate communication) for the facility providing a result of the comparison of the actual operational cost of facility operation to the value proposition for implementing the corresponding action.

The proposal may take the form of the prospectus 116. The prospectus 116 may be an electronic document. The prospectus 116 comprises a digital twin 130b derived from the digital twin 130, and additional information 117 derived from an RDS 140b, the RDS 140b itself being derived from the RDS 140. The prospectus 116 may render to a display of an electronic client computing device a visual representation of the digital twin 130b, or the additional information 117, and may be configured to permit a user to toggle between the digital twin 130b and the additional information 117. The digital twin 130b may permit a user to navigate through the visual representation of the building 10, e.g., to perform a “walk through;” to view portions of the visual representation; to cause a rendering, within the visual representation, of one or more facility items or collections of facility items; etc. The additional information 117 may be similarly navigable in that a user may view select data from the RDS 140b rendered in a human-readable and meaningful at any or several levels of detail. More particularly, the RDS 140b may permit the additional information 117 to render to a display of an electronic computing a high level overview of the proposal (such as, i.e., wherein the actual operational cost of facility operation comprises a sum of operational costs of all facility items), and to permit the user to “drill down” to particular levels of details with regard to, e.g., particular recommendations of the proposal, financial records, financial reports, financial estimates, candidate components to replace current facility items, specifications of components, and more. The prospectus 116 may be updatable by the computing system 110 whereby the current status of the building 10 and systems, subsystems, components, etc., associated with the building 10 are described with respect to their current operational state (as-is condition), and may include a proposal (or a plurality of proposals) to replace, renovate, upgrade, etc., one or more systems, subsystems, components, etc. The prospectus 116 may textually and visually illustrate advantages and benefits of a proposal. The prospectus 116 further comprises financial data to assist in reaching a business decision to implement a proposal. The financial data may comprise past costs associated with the as-is condition, such as ATBF, operating expenses, maintenance costs in the as-is condition, etc. The financial data may further comprise material costs, component costs, and installation costs for implementing a proposal, and, based on the particular building 10, ROI estimates. The prospectus 116 may be communicated 113b, via a network connection or wireless connection, to an electronic computing device, e.g., a computer, a tablet computer, a “smart phone,” etc. and may be rendered to a display of the electronic computing device. The prospectus 116 may further comprise a capability to capture input from a user, e.g., proposal approval, specifications for a component to be recommended, schedule approval, etc., and to communicate 113b such input to the computing system 110. When a user of the prospectus 116 is an appropriate decisionmaker for the building 10, and approves a proposal, or a portion of a proposal, the approved proposal or approved portion of a proposal effectively becomes an upgrade plan. It should be noted that the term “upgrade plan” is used for convenience of the disclosure to refer to an approval of at least one recommendation of a proposal whereby the recommendation is authorized to be implemented, and need not particularly represent an “upgrade” to a facility item, collection of facility items, etc.

With regard to components for potential use in replacing or upgrading a system or subsystem, the UMS 101 may aggregate data from a variety of sources. For example, the UMS 101 may acquire information about a component from the component manufacturer, or from a vendor of the component. The information about a component may comprise dimensional data, power consumption, installation instructions, MTBF, etc. The UMS 101 may acquire information about a component for potential use in a facility in conjunction with a present proposal, or a proposal related to another facility. Once the UMS 101 has acquired information about a component, the information may be retained within the UMS 101 for use with other proposals within the same portfolio as the building 10, or for other buildings unrelated to the building 10. A portfolio may refer to a plurality of buildings owned, or operated, or managed by a common entity.

Furthermore, the UMS 101 may interpolate or apply the information acquired about a component to generate detailed installation plans for use of the component in the building 10. For example, if the information provides that a component may serve a particular volume of space, and may be installed in series of up to five instances of the component, and a particular space of the building 10, based on this information, requires twenty components, the UMS 101 may generate an installation plan implementing four series installations of five components each, and may concurrently generate or update related financial tables. Each such installation plan may be reviewable and manually editable. By way of non-limiting example, a user with appropriate knowledge may adjust the four-by-five series plan to a five-by-four series plan, or to an in-parallel plan, or to use heavier gauge wiring, or to use longer screws, or to use stronger bolts, etc. The UMS 101 may be configured to accept the manual edits and to concurrently update related installation plans and financial data.

In the embodiment of FIG. 1B, a plurality of contractors and vendors 118 is shown, comprising at least a first contractor 118c, a second contractor 118d, and a vendor 118e (collectively hereafter, 118x). The first and second contractors 118c, 118d may be engaged to implement a portion of an upgrade plan generated by the UMS 101 for the building 10. The vendor 118e may be engaged to provide components to be used in implementing a portion of an upgrade plan. Each contractor and vendor 118x may be exposed to a portion of the new data structure 120 relevant to the service or materials each contractor or vendor 118x is to provide. By way of non-limiting example, and for convenience of the disclosure, the first contractor 118c may be engaged to implement a portion of the upgrade plan related to 125V/30 A electrical lighting, and the second contractor 118d may be engaged to implement a portion of the upgrade plan related to 750V/200 A service utilities. The vendor 118e may be engaged to provide some of the components for either or both contractors 118c, 118d.

In the present example, the first contractor 118c may receive 113c a portion 120a of the new data structure 120. The portion 120a comprises a child digital twin 130c and child RDS 140c, each of which excludes data and information not relevant to the work to be performed by the first contractor 118c, and a proposed installation schedule that was generated by the UMS 101. The child digital twin 130c and the child RDS 140c descends from and inherits a set of information from the digital twin 130 and RDS 140. Similarly, the second contractor 118d may receive 113d a portion 120b of the new data structure 120 comprising a child digital twin 130d and RDS 140d limited to data relevant to the work to be performed by the second contractor 118d, and a proposed installation schedule that was generated by the UMS 101. The vendor 118e may receive 113e a portion 120c of the new data structure 120 comprising an RDS 140e, and a proposed delivery schedule for components to be provided by the vendor 118e. Because the vendor 118e is not performing work on the building 10, the vendor 118e may not need a child digital twin, such as the child digital twin 130c, or 130d. In an instance in which the vendor 118e does need a digital twin, one may be provided along with the RDS 140e and delivery schedule. It should be noted that information relevant to the work to be performed by the first contractor 118c may include a portion of the information relevant to the work to be performed by the second contractor 118d. In the present example, the first contractor 118c, during installation of new components, may need to connect a service line to a distribution panel being installed by the second contractor 118d in conjunction with a new power distribution system the second contractor 118d is installing. In this instance, the first contractor 118c would have such information related to the distribution panel necessary to accomplish connection to the distribution panel.

Similarly, in the present example, the vendor 118e may be providing troffers to be installed by the first contractor 118c, but may not be providing exit lighting. In this instance, information about exit lighting would not be provided to the vendor 118e unless some other condition warrants the disclosure.

The UMS 101 may comprise a facilities data set, which may represent an aggregate of data, including, without limitation, a repository of digital twins and RDSes. The facilities data set may be stored at an electronic storage, such as the storage system 111b. A digital twin and RDS in the facilities data set may represent a particular facility at a fixed point in time such that iterative digital twins and RDSes of the facility represent different states of the facility at different times. The facilities data set may comprise digital twins and RDSes of a plurality of facilities. The facilities data set may enable the UMS 101 to employ digital twins and RDSes of a plurality of facilities in order to perform one or more functions of the UMS 101 (e.g., as described elsewhere herein). An owner/operator of a facility may authorize, limit, or restrict use of a digital twin and/or RDS of the pertinent facility in conjunction with providing UMS services for another facility or facilities.

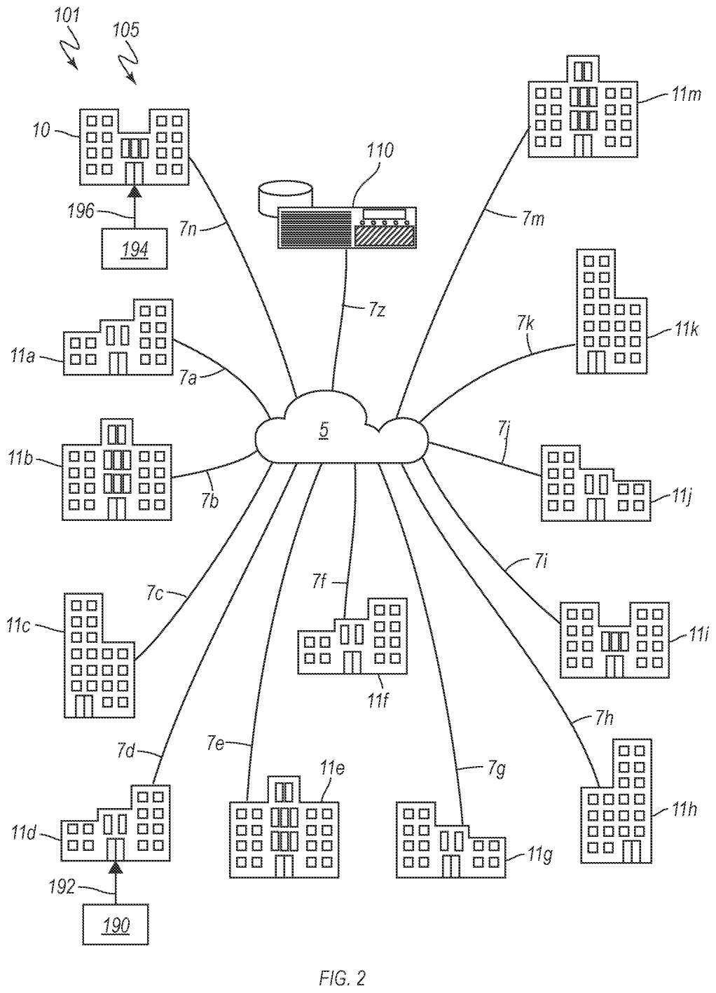

FIG. 2 is a relational diagram of the UMS 101 of FIGS. 1A and 1B, wherein the computing system 110 provides UMS service to a plurality of buildings/facilities 105, according to an embodiment of the present disclosure. The plurality of building/facilities 105 comprises the building 10 and other buildings 11a-11m. The computing system 110 of the UMS 101 may communicate with each member of the plurality of buildings/facilities 105 via the Internet 5. Each of the other buildings 11a-11m has a corresponding connection 7a-7m to the Internet 5. The building 10 has a connection 7n to the Internet 5, and the computing system 110 has a connection 7z to the Internet 5. The number and disposition of the building 10 and other buildings 11a-11m, and their connections 7a-7z to the Internet 5, in FIG. 2 is for convenience of the disclosure and not by way of limitation.

In the embodiment of FIG. 2, the computing system 110 may perform UMS services for the building 10 and for each of the other buildings 11a-11m. As the UMS 101 provides UMS services for any of the buildings 10, 11a-11m, components and services delivered at such building 10, 11a-11m may be aggregated to the facilities data set. The facilities data set may be augmented by external data. The facilities data set may comprise outcome data related to: performance (execution) of a proposal at one or more of the building 11a-11m, implementation costs, post-implementation operating costs, post-implementation performance (such as, e.g., ATBF, maintenance requirements, etc.) The outcome data may comprise information pertaining to an outcome of a completed facility project at a facility (e.g., among the buildings 11a-11m) comparable to the building 10. In performing UMS services for the building 10 and other buildings 11a-11m, the computing system 110 may identify, through correlation, meaningful similarities between some of the buildings 10, 11a-11m. More particularly, the computing system 110 may identify meaningful similarities in a system, subsystem, items used, etc., in two or more of the buildings 10, 11a-11m. For example, the computing system 110 may identify in the other building 11a a heating system that is meaningfully similar to a heating system in the other building 11h. For the purposes of this disclosure, “meaningfully similar[-ity/-ities]” refers to having qualitative and, in some instances, quantitative qualities indicative of essentially similar function and performance. Two fluorescent tube lighting systems may, in some scenarios, be meaningfully similar while an incandescent lighting system may not be meaningfully similar to a fluorescent tube lighting system. In other scenarios, a fluorescent tube lighting system and an incandescent lighting system may be meaningfully similar. One or more statistical or other algorithmic based methods may be used to evaluate the relevance, accuracy, and/or precision of correlations, including artificial intelligence and/or machine learning algorithms. A neural network may be utilized in the process or identifying meaningful similarities and the neural network may be modified or enhanced based new data, including an outcome of or based on the correlation.

As the UMS 101 prepares an upgrade plan, as described herein, for a member of the plurality of buildings/facilities 105, the computing system 110 may acquire data about a new technology 190 as a candidate for replacing a system, subsystem, or items used in the particular member of the plurality of buildings/facilities 105. By way of non-limiting example, as the computing system 110 prepares, as described elsewhere herein, an upgrade plan for the building 10, the computing system 110 may identify a lighting system of the building 10 that is meaningfully similar to a lighting system removed from the other building 11d during an upgrade evolution. The lighting system removed from the other building 11d may have been replaced by a new technology lighting system 190 installed 192 to the other building 11d. In preparing the upgrade plan for the other building 11d, the computing system 110 will have acquired at least some data about the new technology lighting system 190, e.g., physical size, installation parameters, MTBF, operating conditions, etc. Once the new technology lighting system 190 is installed 192 to the other building 11d, the computing system 110 may acquire additional data regarding the new technology lighting system 190, e.g., current operational data (operating time, operating conditions, power consumption, etc.), that inherently become historical operating data over time. The computing system 110 may correlate the various data regarding the new technology lighting system 190 with both the historical operating data of the lighting system replaced in the other building 11d, and the historical operating data of the meaningfully similar lighting system of the building 10. The computing system 110 may determine that the new technology lighting system 190 provides at least one significant benefit for the other building 11d (e.g., reduced power cost, reduced cooling cost, reduced maintenance cost, better lighting, etc.). The computing system 110 may further determine that the new technology lighting system 190 is likely to provide a similar benefit for the building 10. The computing system 110 may, in preparing an upgrade plan for the building 10, develop a building-custom plan for a new technology lighting system 194 for the building 10. In other words, the particular number and disposition of items in the new technology lighting system 194 for the building 10 may be configured to the particular physical qualities of the building 10. The computing system 110 may then recommend adoption of the new technology lighting system 190, in particular, as the new technology lighting system 194 for installation 196 to the building 10. Once the new technology lighting system 194 is operating in the building 10, the computing system 110 may have at least two sources of current and historical operating data regarding the new technology lighting systems 190, 194, whereby the computing system 110 may be further able to correlate the potential for adoption of the new technology light system 190, 194 in other members of the plurality of buildings/facilities 105.

The computing system 110 need not await a particular triggering event to correlate the new technology lighting system 190 of the other building 11d to the building 10. Said otherwise, the computing system 110 does not necessarily wait for a current lighting system of the building 10 to reach an estimated failure state, a particular maintenance state, etc. Rather, the computing system 110 may correlate the various data regarding the new technology lighting system 190 of the other building 11d to the building 10 at any time. In doing so, the computing system 110 may prepare an upgrade plan for the building 10 wherein the current lighting system of the building 10 is to be replaced by the new technology lighting system 194 earlier than may have otherwise been proposed when such early replacement produces an identifiable benefit. For example, the computing system 110 may forecast operating costs for the current lighting system of the building 10 to be substantially higher than the cost of an early replacement of the current lighting system with the new technology lighting system 194, considering installation costs and the operating costs of the new technology lighting system 194 over the remaining expected life of the current lighting system (and beyond). Similarly, the computing system 110 may correlate other factors relevant to the operation of the building 10, such as, e.g., carbon footprint data of the current lighting system of the building 10 with carbon footprint data of the new technology lighting system 194, and may generate an upgrade plan based on such other factors, and the objectives of the owner/operator of the building 10.

It should also be noted that the UMS 101 of FIG. 2 may represent a regional UMS 101. Another UMS, similar in at least some respects to the UMS 101, may operate in a neighboring region, or even in a distant region, and may function together with the UMS 101 in a network fashion. Each UMS may exchange with another UMS data relevant to developing upgrade plans and operations of buildings or facilities whereby new technology, such as the new technology lighting systems 190, 194 may be appropriately adopted into buildings or facilities throughout such a UMS network. In other words, the UMS 101, and other UMS installations, may promote a more rapid adoption of a new technology, such as the new technology lighting systems 190, 194, than may otherwise organically occur. Such rapid adoption may result in cost savings for owners/operators of buildings or facilities, improved conditions for employees/workers in such buildings or facilities, improved carbon emission, etc.

In one embodiment, the computing system 110 may perform UMS services for the building 10, and may perform UMS services for a subset of the other buildings 11a-11m, or for none of the other buildings 11a-11m. In performing UMS services for the building 10, the computing system 110 may acquire relevant data (an external data set comprising relevant data of one or more buildings external to the UMS 101) in order to identify, through correlation, meaningful similarities between some of the buildings 10, 11a-11m. By way of non-limiting example, the UMS 101 may acquire regional information related to (a) the region wherein the subject facility is located, (b) facilities of a similar type to the subject facility, and installed items (and item-related data, such as, e.g., number or density of items, cost of operating the items, local energy cost, etc.), etc. More particularly, the computing system 110 may identify meaningful similarities in a system, subsystem, items used, etc., in two or more of the buildings 10, 11a-11m, and may perform as otherwise described in conjunction with FIG. 2.

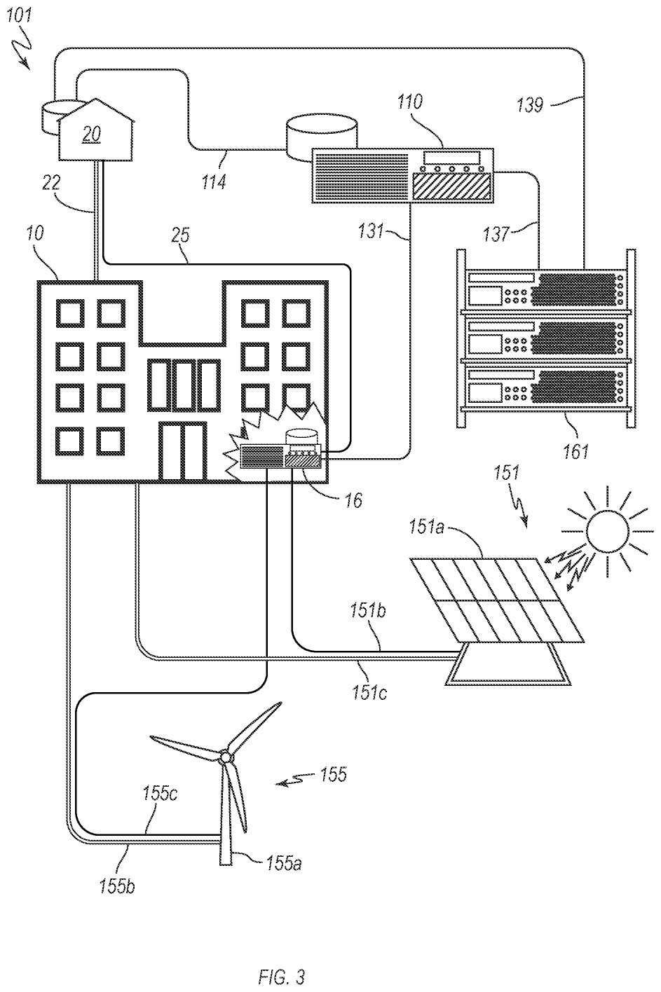

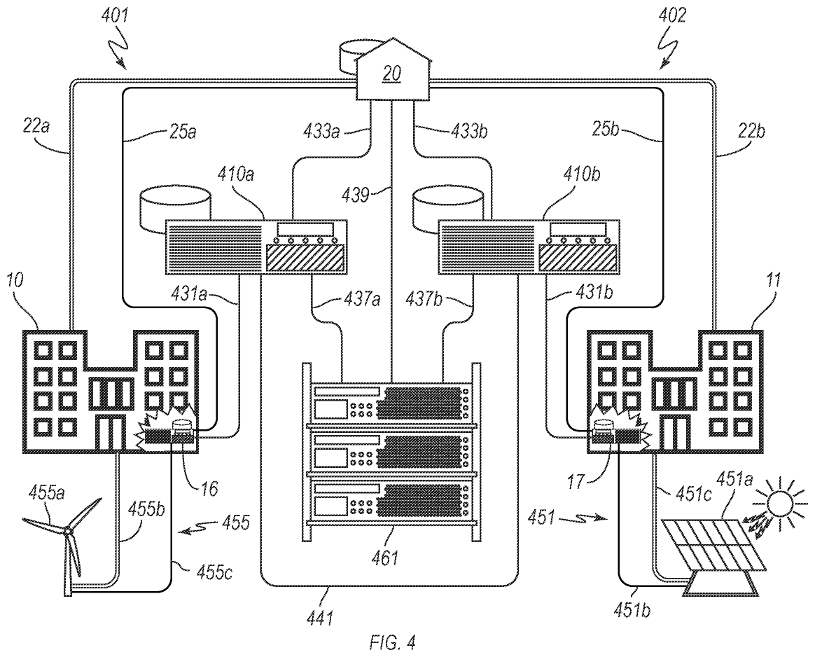

FIG. 3 is a relational diagram of the UMS 101 of FIGS. 1A and 1B, wherein the building 10 is both a consumer of a service and a producer of the service, according to an embodiment of the present disclosure. The computing system 110 is shown having communication 114 with a service provider 20, as well as communication 131 with the BMS 16. The building 10 is a consumer of a service provided by the service provider 20. The service provider 20 produces and provides electrical power; however, this is a non-limiting example for the convenience of the disclosure, and other service provisioning is anticipated by the disclosure. The building 10 receives electrical power from the service provider 20. Furthermore, the building 10 may be configured to produce electrical power. For example, the building 10 may comprise a photovoltaic power system 151 and/or a wind power system 155. The photovoltaic power system 151 comprises a collection/conversion system 151a configured to receive sunlight and convert it to electrical power. The photovoltaic power system 151 comprises a communication channel 151b configured to permit communication between the BMS 16 and the photovoltaic power system 151. Communication between the photovoltaic power system 151 and the BMS 16 may permit the BMS to receive operational data regarding operation of the photovoltaic power system 151 and its components, which, in turn, may be used by the UMS 101 for a variety of purposes, as described elsewhere herein. The photovoltaic power system 151 further comprises a power transmission system 151c to deliver electrical power from the collection/conversion system 151a to the building 10.

The wind power system 155 comprises a power generation system 155a to convert wind power to electrical power, a communication system 155b similar to the communication system 151b of the photovoltaic power system 151, and a power transmission system 155c. The photovoltaic power system 151, or the wind power system 155, or both, may provide to the building 20 at least a portion of the total electrical power the building 10 may require. The amount of electrical power provided to the building 10 by the photovoltaic power system 151 may vary cyclically, for example, providing more power during summer daylight hours, and less power during winter daylight hours, and potentially near no power during night hours. Similarly, the wind power system 155 may provide a varying amount of electrical power, such as providing more power when an operationally-appropriate wind is present, and less to no power when an operationally-appropriate wind is not present. To the extent the building 10 is able to draw upon electrical power from the photovoltaic power system 151 and/or the wind power system 155, the building 10 may reduce its dependency on electrical power from the service provider 20.

As the building 10 utilizes the photovoltaic power system 151 and/or the wind power system 155 to provide electrical power for itself, the BMS 16 may deliver to the UMS 101 data regarding production of power by the photovoltaic power system 151 and/or the wind power system 155. The UMS 101 may employ power cost data (current and historical) from the service provider 20, and operational data from the BMS 16 regarding the photovoltaic power system 151 and/or wind power system 155 to generate a calculation of service costs. Furthermore, the UMS 101 may generate an optimal purchase of service based on the current and historical cost of service from the service provider 20 and the operational data of the photovoltaic power system 151 and/or wind power system 155 from the BMS 16. An optimal purchase of service from the service provider may include pre-purchase of service at one cost in expectation of an increasing cost at a future date when the pre-purchased service may actually be consumed by the building 10. Pre-purchased service may be monitored and managed using a pack chain (described hereafter) and may be recorded and registered via a secure system, such as a blockchain system 161. Pre-purchased service may function as a service-as-a-commodity, as described below. Furthermore, in addition to energy improvement through adoption of clean energy generation at the building 10, other improvements resulting from the methods and systems herein described may produce energy efficiency whereby a surplusage of energy is created. For example, a change in lighting systems throughout the building 10 may result in a decrease in power consumption over a succeeding period. In other words, improvements to the building 10 may constructively generate efficiency energy (energy that would have been used at one rate in a legacy system being replaced or updated but now to be used at a lower rate in an improved legacy system or a new system). It should be noted that while the present disclosure discusses electric power as a preferred embodiment, the systems and methods herein described may be applied to other services.

A communication channel 25 may permit communication, e.g., data communication, between the BMS 16 and the service provider 20. The communication channel 25 may comprise any relevant appropriate hardware, firmware, and software to facilitate communication between the BMS 16 and the service provider 20. A communication channel indicated elsewhere in the present disclosure may similarly comprise relevant appropriate hardware, firmware, software, protocols, etc. to enable the particular communication across or via the communication channel. The communication channel 25 may be configured to permit the BMS 16 to adjust service delivery from the service provider 20. The communication channel 25 may be further configured to enable the BMS 16 to purchase or pre-purchase service from the service provider 20. In an embodiment in which the BMS 16 pre-purchases service from the service provider 20, the communication channel 25 may permit the service provider 20 to deliver to the BMS 16 an electronic token representing the BMS 16 interest in future service, a process which constructively converts the pre-purchased service to service-as-a-commodity. For the present example, the service provider 20 may be an electric power service provider. Electric power, for example, may be transmitted from the service provider 20 to the building 10 over a power transmission system 22.

In one embodiment, the communication channel 114 between the UMS 101 and the service provider 20, in addition to facilitating providing current and historical data to the UMS 101, may permit the UMS 101 to effectively purchase or pre-purchase service from the service provider 20 on behalf of the BMS 16 or building 10. The communication channel 114 may also permit the service provider 20 to deliver to the UMS 101 an electronic token representing the interest in future service (service-as-a-commodity) of the UMS 101, the BMS 16, or the building 10. In an embodiment in which the BMS 16 purchases the service-as-a-commodity, the BMS 16 may further communicate the electronic token to the UMS 101 via the communication channel 131. A token may be generated upon a pre-sale of the service-as-a-commodity, when efficiency improvements at the building 10 result in a surplusage of the service (whereby tokenizing the surplusage converts the surplusage to a service-as-a-commodity), and when a service is initially generated (such that tokenizing the generated service enable exchange of the service as a service-as-a-commodity). In other words, while the disclosure more particularly discusses service-as-a-commodity and token in the context of sale and pre-sale of the service, the same methods and functions similarly apply to instances in which a surplusage of a service is created through efficiency, or when the service is generated (e.g., megawatts generated at a generator). The UMS 101 may employ a communication channel 137 to communicate with a blockchain service 161 in order to embed the electronic token representing the service-as-a-commodity into a block of a blockchain in which the blockchain service 161 is participating. As is known in the art, embedding data, e.g., an electronic token representing service-as-a-commodity, in a block of a blockchain creates a trustless and immutable record of the data. The trustless and immutable record of the data may comprise the electronic token itself, as well as related information, such as, e.g., a date and time of the transfer of the interest represented by the electronic token to the UMS 101, the BMS 16, or the building 10, as quantity of service-as-a-commodity represented by the electronic token, title (current ownership of the electronic token), etc. At a future date (relative to the pre-purchase of the service-as-a-commodity), the electronic token can be “redeemed” to the service provider 20 by reading the electronic record from the latest block of the blockchain, determining that no redemption has been recorded relative to the electronic token, re-presenting the electronic token to the service provider 20, and re-registering the electronic token to the next block of the blockchain wherein the re-registration effectively terminates or updates the interest in the service-as-a-commodity represented by the electronic token. An update of the interest may comprise a change in a quantity of service represented by the electronic token, a change of party in whom the interest vests, etc. The token may be configurable in an orderly manner to facilitate a change of state in the particular consumable service or product (e.g., from a future production state to a produced state, a delivered state, a consumed/used state, etc.), the quantum, or in ownership (e.g., sale or other transfer (in whole or in part), dissolution, etc.). The token also may represent an exchange value of the quantum of the consumable service or product (e.g., a price for the particular quantum), or an exchange value of a standard quantity of the consumable service or product (e.g., a price for unit (such as a megawatt/hour of electricity) of the consumable service or product). Because exchange rates and prices may be driven or influenced by local market conditions, the token may include a localization identifier whereby a locality of the quantum of the consumable service or product is identified. The localization identifier may enable exchange of the token within the local market, as well as cross-exchange across markets. In other words, the localization identifier may enable an exchange between two or more entities in the same market without adjustment for local variance in the market, and may also enable calculation of an adjustment (an exchange differential) based on market variances or differences between different markets.

The photovoltaic power system 151 and/or the wind power system 155 may allow the building 10 to employ power from either/both of the power systems 151, 155 during periods when service costs may be higher, thereby potentially reducing service provision costs. Furthermore, the building 10 may, using the BMS 16 and/or UMS 101, sell power generated by the power systems 151, 155 to the service provider 20. Power may be transmitted from the building 10 to the service provider 20 on the power transmission system 22.

The UMS 101 may, as described elsewhere herein, develop a plan to update or replace a component or system of the building 10 at a time after a pre-purchase of service-as-a-commodity has been perfected. An update or replacement of a component may result in a net reduction of use of the service provided by the service provider 20. In an event wherein an update or replacement of a component of the building 10 results in a net reduction of use of the service provided by the service provider 20, pre-purchased service-as-a-commodity may become surplus commodity, which the UMS 101 may continue to hold against future use, potentially beyond the period for which the original pre-purchase was intended, or may offer the service-as-a-commodity, or portion thereof, for sale back to the service provider 20, or to another service consumer. Sale of the service-as-a-commodity, or portion thereof, and, hence, change of interest, may be recorded to a blockchain, as described above, and as is known in the art, through the blockchain service 161.

While FIG. 3 discusses a service-as-a-commodity in the form of electrical power, this if for the convenience of the disclosure and not by way of limitation. The disclosure anticipates other services may be similarly handled by the UMS 101 as a service-as-a-commodity. As a further and non-limiting example, the building 10 may comprise a server farm to provide computing service for users of the building 10 or clients. To accommodate peak usage of computing service, the UMS 101 may purchase or pre-purchase as a service-as-a-commodity computing service from a service provider, e.g., Amazon Web Services. Furthermore, in response to planned or anticipated underutilization of the computing services of the building 10, excess computing service capacity may be sold or pre-sold through tokens. Additionally, exchanges-in-kind, or other trades may be accomplished through the UMS 101, wherein purchases, pre-purchases, sales, pre-sales, exchanges, trades, etc., may be recorded via blockchain technology to provide trustless and immutable records of all such transactions.

FIG. 4 depicts an embodiment of a UMS 401 that resembles the UMS 101 described above in certain respects. Accordingly, like features are designated with like reference numerals, with the leading digit(s) incremented to “4.” For example, the embodiment depicted in FIG. 4 includes computing systems 410a, 410b that may, in some respects, resemble the computing system 110 of FIGS. 1A-3.

Relevant disclosure set forth above regarding similarly identified features thus may not be repeated hereafter. Moreover, specific features of the computing system 110 and related components shown in FIGS. 1A-3 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the computing systems 410a, 410b and related components depicted in FIG. 4. Any suitable combination of the features, and variation of the same, described with respect to the computing system 110 and related components illustrated in FIGS. 1A-3 can be employed with the computing systems 410a, 410b and related components of FIG. 4, and vice versa. This pattern of disclosure applies equally to further embodiments depicted in subsequent figures and described hereafter, wherein the leading digits may be further incremented.

FIG. 4 is a relational diagram of a UMS 401 and a UMS 402, wherein both UMSs 401 and 402 are similar to the UMS 101 of FIGS. 1A-3 in at least some respects, according to an embodiment of the present disclosure. The UMS 401 comprises the building 10, the service provider 20, a computing system 410a, and a blockchain system 461. The BMS 16 of the building 10 is shown for reference. The building 10 comprises a wind power system 455. The wind power system 455 comprises a power generating system 455a, and an electric power transmission system 455b to deliver electric power to the building 10. A communication channel 455c enables communication between the wind power system 455 and the BMS 16. A computing system 410a is shown, analogous in at least some respect to the computing system 110 of FIGS. 1A-3. A communication channel 431a enables communication between the BMS 16 and the computing system 410a. A communication channel 433a enables communication between the computing system 410a and the service provider 20. A communication channel 437a enables communication between the computing system 410a and the blockchain system 461.

The UMS 402, in the present embodiment, comprises some of the same entities as the UMS 401, and a number of entities analogous, similar to, or having similar functions as their counterparts of the UMS 401. The service provider 20 provides service to the building 10 of the UMS 401, and to a building 11 of the UMS 402. A computing system 410b, and a BMS 17 function similar to their respective counterparts (the computing system 410a, the BMS 16, respectively) of the UMS 401. Similarly, communication channels 25b, 431b, 433b, and 437b function similarly to their respective communication channels 25a, 431a, 433a, and 437a of the UMS 401. A communication channel 441 may enable communication between the computing system 410a and the computing system 410b. The building 11 comprises a photovoltaic power system 451. The photovoltaic power system 451 comprises a collection/conversion system 451a, and a power transmission 451b. A communication channel 451c enables communication between the photovoltaic power system 451 and the BMS 17.

As depicted in FIG. 4, both UMSs 401, 402 communicate with the blockchain system 461. The blockchain system 461 may comprise a plurality of participating computing systems participating in a blockchain. In one embodiment, the computing system 410a, or the computing system 410b, or both, may participate in the blockchain directly. Both the building 10 and the building 11 may purchase or pre-purchase service from the service provider 20 (service-as-a-commodity), and may transact in recordation, via the blockchain system 461 to a block of a blockchain, of an electronic token that represents an ownership interest in service yet to be produced and provided by the service provider 20. Because the buildings 10, 11 employ differing power generation systems 451, 455, and because the buildings 10, 11 may otherwise have differing power demands, they may each purchase or pre-purchase service-as-a-commodity from the service provider 20. Furthermore, the buildings 10, 11, through their respective BMS 16, 17, and or UMSs 401, 402. Furthermore, the buildings 10, 11, through the UMSs 401, 402, may negotiate a trade whereby, for example, the building 10 transfers an interest in pre-purchased service of the service provider 20 to the building 11. Such a transfer may be recorded to a block of a blockchain via the blockchain system 461 by the UMSs 401, 402. Similarly, the building 10, or the building 11, may direct-sell future overproduction of power from the respective power generation system 451, 455 to the other building 10, 11. The selling building 10, 11 may, similar to the service provider 20, generate an electronic token representing an ownership interest in the future production of power by the respective power generation system 451, 455. The electronic token may be recorded to a block of a blockchain via the blockchain system 461 by either or both UMSs 401, 402.

In the illustration of FIG. 4, two UMSs 401, 402 are represented; however, the disclosure anticipates an embodiment in which the building 10 and the building 11 may both be within a single UMS, and the treatment of service-as-a-commodity is handled within that UMS, and recordation of each transaction is via the blockchain system 461 to create a trustless and immutable record. In one embodiment, the building 11, for example, may employ a different facility management system rather than a UMS. The building 11 may acquire from the building 10 an interest in a service-as-a-commodity that is recorded in the blockchain of the blockchain system 461 by the UMS 401 on behalf of the building 10 (and, simultaneously, the building 11). Similarly, the UMS 401 may acquire, on behalf of the building 10, an ownership interest in a service-as-a-commodity held by the non-UMS-participating building 11, with the transaction recorded to a blockchain via the blockchain server 461.

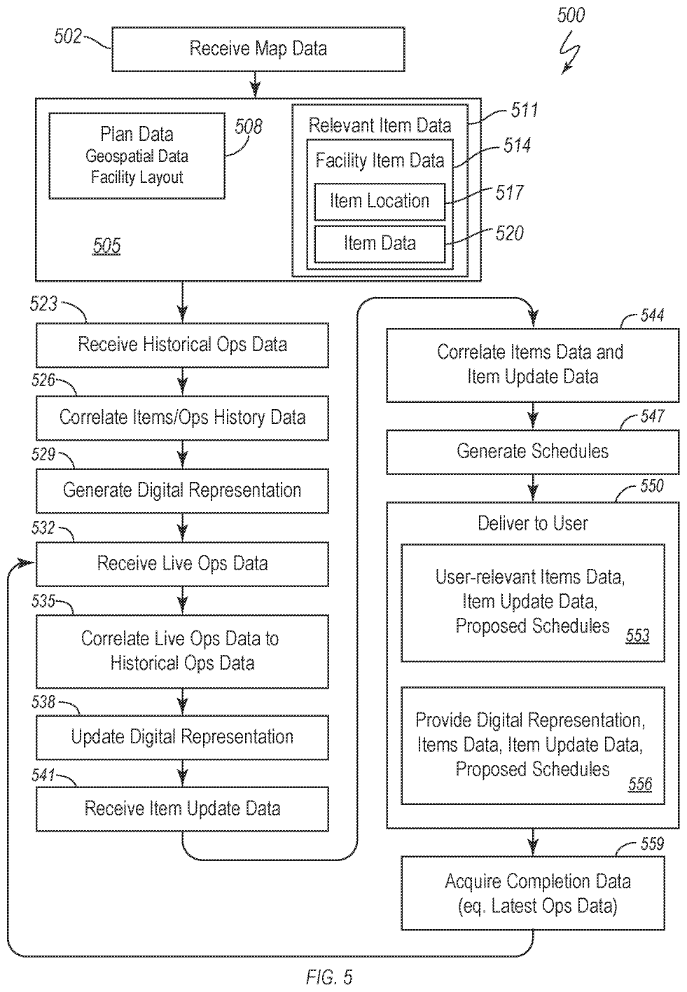

FIG. 5 is a flowchart illustrating a method 500 of a UMS (e.g., the UMS 101 of FIGS. 1A and 1B) of managing a facility, such as a building (e.g., the building 10 in FIG. 1A). In general terms, the method comprises generating a proposal for a facility, the proposal comprising a set of one or more recommendations each pertaining to one or more corresponding facility items, each recommendation comprising an action to be performed (or otherwise implemented) in relation to the one or more corresponding facility items and a value proposition for performing (or otherwise implementing) the action; transmitting the proposal to a human point of contact for the facility, a service provider, a vendor, etc.; capturing input from a human user and from other data sources to cyclically iterate through the method 500.

A UMS may receive facility data for a target facility (facility) of a potential facility project. More particularly map data for the facility is received 502. The facility may be an existing facility (i.e., a place comprising at least a physical structure constructed or otherwise installed for an activity or to serve a function), or may be a planned facility not yet constructed or installed. The facility data may include one or more of item data for facility items of the target facility that are relevant to the potential facility project, location data of each facility item within a layout of the facility, and/or operational data for the target facility. The map data may be organized 505 to group 508 plan data and to group 511 relevant item data. The plan data comprises geospatial data (e.g., an address, global positioning system (GPS) locating data, climate data, etc.), and facility layout information (e.g., a site plan, exterior dimensions, interior dimension, location of interior walls, floor plan, reflected ceiling plan, etc.). The map data may comprise a site map, the site map provided through the plan data or the relevant item data, or both. The relevant item data may be further grouped 514 into facility item data (e.g., item locations within/at the facility, item data/specifications, etc.). The facility item data may relate to facility equipment relevant to operation of the facility. Facility equipment may include fixtures (e.g., a lighting fixture, router, photovoltaic panel, etc.). The facility item data can be organized 517, 520 into, respectively, item location (i.e., location of the facility item within/at the facility) and item data (i.e., manufacturer, model, specifications from the item manufacturer describing the items physical and operational characteristics, information regarding installation of the item and/or integration to the facility or other facility items, etc.). The relevant item data for one or more facility items further includes operational system information describing a collection of facility items performing an operation of a facility (e.g., an HVAC system, waste water system, etc.). Said otherwise, the method comprises receiving map data of an existing facility (e.g., the building 10) i.e., a place comprising at least a physical structure constructed and/or installed for an activity or to serve a function, the map data including plan data providing a layout of the facility and relevant item data for one or more facility items, including a location of each of the one or more facility items within the layout of the facility.

The UMS may receive 523 historical operational data about the facility and a system and/or components of the system of the facility. In other words, the method 500 comprises receiving historical operational data (e.g. usage; hours of operation, control schemes, energy consumption, etc.) providing historical operating conditions of the facility (potentially up to the present moment), including the one or more facility items (or components).

The UMS correlates 526 the historical operational data with the map data. One or more statistical or other algorithmic based methods may be used to evaluate the relevance, accuracy, and/or precision of the correlation, including artificial intelligence and/or machine learning algorithms. For example, a neural network may be utilized in correlating and the neural network may be modified or enhanced based on the correlating and/or an outcome based on the correlating. This correlation 526 may be used to generate at least some of the financial data related to a system or components of the facility.

The UMS generates 529 a digital representation of the facility, as well as systems and components of the facility. The method 500 further comprises converting the map data and historical operational data into a digital representation of the facility. The digital representation is an accurate, logical representation of the facility in a present condition. The UMS may receive 532 live operational data. The live operational data may comprise information regarding recent component replacements, and current costs of operation of the facility, or a system, or components of the facility. Said otherwise, the method 500 comprises receiving live operational data providing present (e.g., current or updated) operating conditions of the facility. The UMS correlates 535 the live operational data with the historical operational data. This correlation 535 may generate a more accurate depiction of the financial effect of the present condition and going forward without implementing an upgrade plan. One or more statistical or other algorithmic based methods may be used to evaluate the relevance, accuracy, and/or precision of the correlation, including artificial intelligence and/or machine learning algorithms. For example, a neural network may be utilized in correlating and the neural network may be modified or enhanced based on the correlating and/or an outcome based on the correlating.

The UMS may update 538 the digital representation utilizing the live operational data by removing, replacing, and adding any components shown by the live operational data to have been removed, replaced, or added. The UMS may update the digital representation of the facility with the present operating conditions of the facility (and the new designed/installed facility item) to ensure the digital representation continues to provide accurate representation of the facility. In other words, the UMS may provide a digital, three-dimensional (3D) visualization of the facility to a user, the visualization generated from the digital representation, the visualization to render for the user the layout of the facility, the one or more facility items, and operating conditions of the facility.

The UMS may receive 541 item update data. The item update data may represent candidate components for replacing, upgrading, or augmenting current facility items at the facility. Said otherwise, candidate component (or item) data is received for candidate components relevant to the potential facility project, the candidate components each having one or more meaningful similarities with one or more of the facility items. A facilities data set (described elsewhere herein) may be accessed, the facilities data set including comparable (or similar) facility data of a plurality of comparable (or similar) facilities each having one or more meaningful similarities with the target facility, the comparable facility data including item data for facility items of the plurality of comparable facilities. The facilities data set may further provide location data of each facility item within a layout of each of the plurality of comparable facilities, and/or operational data for the plurality of comparable facilities.

The UMS may correlate 544 the items data 517 with the item update data to logically locate new components in the digital representation. One or more statistical or other algorithmic based methods may be used to evaluate the relevance, accuracy, and/or precision of the correlation, including artificial intelligence and/or machine learning algorithms. For example, a neural network may be utilized in correlating and the neural network may be modified or enhanced based on the correlating and/or an outcome based on the correlating.

The UMS may generate 547 schedules. Schedule generation 547 may comprise creation of data tables related to components to be installed, and generation of one or more proposed installation schedules. In other words, one or more actions may be determined for the potential facility project in relation to (or involving) one or more of the facility items and one or more of the candidate components. Furthermore, a value proposition, such as an ROI or satisfying an objective of an owner or occupant of the facility, may be determined for performing or implementing the action based on the facility data for the target facility, the facility data of the plurality of comparable facilities, and the candidate component data. An expenditure value is determined for performing or implementing the action. An ROI is calculated based on the value proposition value and the expenditure value.

The UMS may deliver 550 a collection of data to each user, and a user interface to facilitate rendering the collection data to a display of a client computing device and capturing input from a user of the client computing device. A user may be an owner, operator, manager of the facility, or of a portfolio that includes the facility; a contractor (e.g., see the plurality of contractors and vendors 118 in FIGS. 1A and 1B, and the first and second contractors 118c, 118d in FIG. 1B), a vendor (e.g., see the vendor 118e in FIG. 1B), a sales representative; or another user designated within the UMS. Each user may receive 553 user-relevant items data, item update data, and proposed schedules, as further described in conjunction with FIG. 1B. A user may further provide input via the user interface to, for example, select a product to be included as one of a new facility item or upgrade facility item in a proposal for the facility, enter data (i.e., specifications) for a facility item or upgrade facility item, approve a recommendation or proposal, modify or improve on a recommendation, etc. The UMS also provides 556 a digital representation (e.g., see the digital twin 130 and child digital twins 130c, 130d in FIG. 1B), items data, items update data, and proposed schedules. The information provided may take the form of a prospectus (e.g., see the prospectus 116 in FIGS. 1A and 1B). In other words and with respect to an appropriate decisionmaker (e.g., an owner, operator, manager, computing system, etc., of the facility), a recommendation is provided to a point of contact for the target facility, the recommendation including the action(s) of the proposed facility project, the one or more facility items, the one or more candidate components, and one or more of the value proposition value, the expenditure value, and the ROI. The point of contact may be the facility owner, operator, occupant, a designee, a computing system, etc. The point of contact for the facility may be local or remote to the facility. The point of contact may be responsible relative to or loosely affiliated with the facility. The point of contact for the target facility may be a third-party, such as a sales representative, vendor, consultant, etc. The point of contact may be a computing system.

The proposed installation schedule can be delivered to each contractor. Each contractor or vendor can accept the proposed installation schedule, may propose a new installation schedule, may decline the proposed installation schedule (which may include declining the install job), or (as appropriate) indicate completion or partial completion of the installation schedule to the UMS. The UMS treats each acceptance, new proposal, decline, and completion as receiving 532 live operational data for the facility. Once an installation schedule has been accepted, a contractor or vendor may request a modification. If the UMS receives an installation schedule modification request, the UMS may correlate the various installation schedules to assess the impact on each installation schedule, and may forward the update request, along with the impact assessment, to a relevant decisionmaker for action. Furthermore, the UMS may adjust one or more installation schedules based on the assessment, provided the adjustments fall within acceptable completion parameters.

When a contractor or vendor completes or partially completes an installation schedule, the contractor or vendor may provide completion data (as through a particular RDS (e.g., see the child RDS 140c, 140d, 140e in FIG. 1B). The UMS may acquire 559 the completion information. The UMS may handle the acquired completion information as receiving 532 live operational data. In other words, the UMS may immediately update the new data structure such that the digital twin and RDS (e.g., see the new data structure 120, the digital twin 130 and RDS 140 in FIG. 1B) accurately reflect the new current state of the building 10.

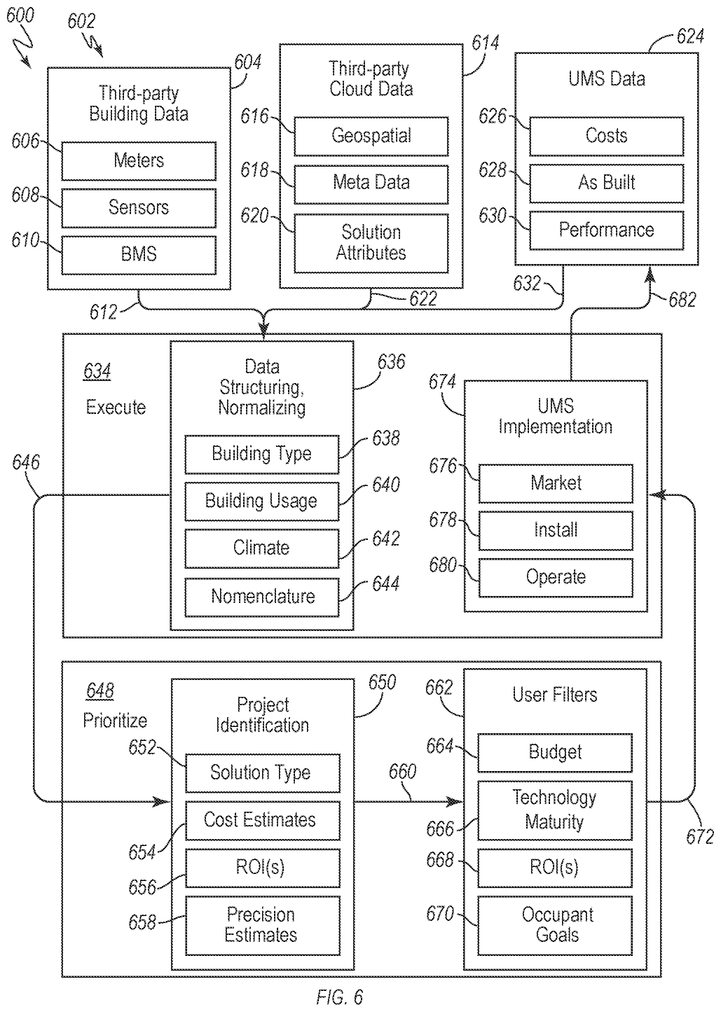

FIG. 6 is a flowchart further illustrating a method 600 of operation for a UMS, according to an embodiment of the present disclosure. More particularly, the method 600 comprises a cyclical logic 602 and/or pattern of the UMS. The method 600 entails a plurality of data comprising third-party building data 604, third-party cloud data 614, and UMS data 624. The third-party building data 604, generally, represents historical operation of the facility (see the building 10 in FIG. 1A). The third-party building data 604 may be acquired from a variety of sources (e.g., utility companies, service providers, etc.). The third-party building data may comprise data from meters 606 (e.g., utility meters, submeters, etc.), sensors 608, and the BMS 610. The third-party building data 604 may further comprise data such as, e.g., physical dimensions of the facility, usage of the facility, age of the facility, etc. The third-party building data 604 may also comprise ownership-related data which may, in particular, identify appropriate decision-makers who may be involved in determining to adopt a proposal designed by the UMS, as well as an objective, a goal, or a value proposition of the appropriate decision-maker(s) related to a potential proposal.

The third-party cloud data 614 may comprise geospatial data 616, property meta-data 618, solution attributes data 620, etc. The geospatial data 616 may be acquired from any of a variety of sources, such Google Maps™ mapping service, a geographic information system (“GIS”) mapping service, county assessor GIS or other data maps or physical maps, etc., mobile mapping applications, mobile measuring applications, mobile GIS applications, etc. The property meta-data may comprise data related or similar to geospatial data, and may be sourced from, e.g., commercial real estate websites, commercial real estate applications, county assessors, etc. The solution attributes data 620 may comprise utility and incentive data, as well as general and particularized data regarding components presented in a proposal generated by the UMS, such as specifications, restrictions, installation requirements and/or guidance, power consumption, water usage, service requirements, manufacturer MTBF, estimated ATBF particularized to the facility, etc. The relevant item data for the one or more facility items further includes specifications (i.e., equipment or fixture specifications) for at least the one or more facility items that comprise operational equipment, the specifications provided by a manufacturer of each facility item to describe its physical and operational characteristics (i.e., how it is designed to perform/operate); and may further comprise the relevant item data for the one or more facility items further includes integrations for at least the one or more facility items that comprise operational equipment, the integrations of each facility item to describe how it integrate to other facility items. The utility and incentive data may comprise information regarding utility providers, utility rates (current and historical), tariffs, private incentives and/or rebates, government-sponsored incentives and/or rebates, etc. The solution attributes data 620 also comprises cost data such as, e.g., component acquisition cost, component installation cost, component lifetime maintenance cost, etc. The solution attribute data 620 may further comprise property value of the property as currently built, property value after installation, impact of the UMS-generated proposal on property value over time, etc.

The UMS data 624 at least costs data 626, as-built data 628 (project actuals), and performance data 630. The costs data 626 may comprise project estimates, such as data about the cost of an entire proposal generated by the UMS, cost of portions of the proposal, etc., cost of a particular system in the proposal, etc., to a granular level such as individual component cost. The costs data 626 may comprise energy data, such as an estimate of energy required to implement a proposal generated by the UMS, and the cost of the energy estimated for the implementation, and may be reflected as an overall estimate or an estimate at any level or stage, including granularly to individual subsystems or components, etc. The costs data 626 may also comprise data related to available incentives, which may include value of an incentive, program requirements for an incentive, timing matters related to an incentive, value of the incentive in the project, value of the incentive in property value, etc. The costs data 626 may also comprise equipment data, such as, e.g., particular equipment required for implementing all or a portion of the proposal, cost of acquiring (purchase, lease, rent) the equipment, value of the equipment over time (when purchased), cost of operating the equipment, etc. The costs data 626 may further comprise property value data, such as the property value before and after implementing a proposal generated by the UMS, and the property value in the future (with and without the implementing the proposal).

The as-built data 628 may comprise project actual costs data corresponding to data of the project estimates and reflecting the actual affect. By way of non-limiting example, the costs data 626 may contain a price of a widget based on pre-acquisition data, while the as-built data 628 may reflect an actual acquisition cost of the widget. In other words, the costs data 626 may include an estimate to purchase one widget for $100, and the as-built data 628 may reflect an actual cost of $99.05 at time of purchase. Similarly, the as-built data 628 may reflect application of an incentive as realized, which may vary (or be absent) from any incentives in the costs data 626. The as-built data 628 may be updated in real time or near-real time as materials are purchased, expenses are invoiced/paid, etc., and may permit a user to view the actual expenses of a project to date, as well as updated completion costs. The costs data 626 and as-built data 628 may be integrated such that the costs data 626 may be updated in real time as the as-built data 628 are acquired.

The as-built data 628 may further comprise data regarding the facility historically, at a present moment, or at a future time. In other words, the as-built data 628 may reflect the facility as it exists prior to implementing a proposal generated by the UMS 101, the facility as it exists at a particular moment during implementation of a proposal, or the facility as it exists upon completion of the proposal. Furthermore, the as-built data 628 may be updated as maintenance is performed during or after implementation of a proposal generated by the UMS, or as any future proposal generated by the UMS is implemented. The as-built data 628 may also be updated when a natural event, e.g., a major storm, an earthquake, etc., degrades any portion of the facility.

The performance data 630 may comprise data reflecting operation of systems, subsystems, components, etc. of the facility, including maintenance and replacement costs incurred over time. The performance data 630 may acquire data over time to establish ATBF for components as installed at the facility, and further may be used to establish or update a maintenance schedule. The performance data 630 may also be used by the UMS to assess maturity of technology present in systems, subsystems, or components installed to the facility. Information about the maturity of a technology as used in the facility may be beneficial in assessing the technology for a future proposal to be generated by the UMS for the facility, or for a proposal for another facility. The performance data 630 may be utilized to validate or improve on date related to ROI(s) (see the ROI(s) 656, 668 below), and may further facilitate development of a future proposal to be generated by the UMS.

The third-party building data 604, the third-party cloud data 614, and the UMS data 624 may be acquired 612, 622, 632, respectively, by the UMS to commence generation of an upgrade proposal, and at intervals as appropriate. Some data comprising the third-party building data 604, the third-party cloud data 614, or the UMS data 624 may be acquired at fixed intervals, or on a demand basis, or may be automatically acquired in real time or near-real time. The UMS performs (executes) 634 transformation of the third-party building data 604, the third-party cloud data 614, and the UMS data 624 through data structuring and normalizing 636. Data structuring and normalizing 636 may comprise parsing the acquired data 604, 614, 624 to a sufficiently granular level to permit correlating the granular data and generating meaningful data structures 638-644 in support of creating and implementing a proposal. By way of non-limiting example, one or more of the actual operational cost of facility operation and the value proposition for performing the corresponding action may be compared either (i) a total actual operational cost of the facility to a total anticipated operational cost of the facility OR an actual operational cost of the corresponding facility items to which pertains the implemented actions to the value proposition for performing the action.

The meaningful data structures 638 644 may be intermediate stages in transforming the acquired data 604, 614, 624 into one or more proposals for the building 10. Such meaningful data structures 638 644 may comprise building type data structure(s) 638, building usage data structure(s) 640, climate data structure(s) 642, and nomenclature data structure(s) 644. Hereafter, “data structures” or “data structure(s)” may be referred to in the singular; however, the disclosure anticipates that a plurality is inherently incorporate to the reference.

The building type data structure 638 may reflect physical characteristics of the facility, such as number of stories, height of each story, height of the building, underground stories and structures of the building, footprint shape of the building 10, footprint dimensions of the building 10, distinctive footprint shape and dimensions for any story of the building 10, construction style of the building 10, construction materials of the building 10, insulation and/or insulative impact of construction materials of the facility, etc. The building usage data structure 640 may comprise data related to how the facility is used. The building usage data structure 640 may reflect the degree of occupancy of the facility as a whole, or in particular portions; may reflect hours of occupancy (e.g., Monday-Friday 7 AM to 7 PM, etc.), variations in occupancy (for example, due to holidays, etc.), the nature of the usage (for example, e.g., a bakery in a portion of the facility, with its concordant power, computing, and gas usage; a law office in another portion of the facility with a different concordant power, computing, and gas usage; etc.), variations in traffic within the facility, etc.

The climate data structure 642 may comprise data related to climatology for a region wherein the facility is sited. The climate data structure 642, more particularly, may comprise data regarding climate variations seasonally, as well as over protracted periods of time. The nomenclature data structure 644 may comprise data that identifies various components, including facility items, or aspects of the facility, in particular when such components or aspects may be identified by varied data as acquired from the various sources 604, 614, 624. In other words, the nomenclature data structure 644 may, for example, relate “widget” from one data source 604, 614, 624 and “Widget” from within the same or a different data source 604, 614, 624 as representing the same component. Similarly, the nomenclature data structure 644 may relate “00036891c” from one data source 604, 614, 624 and “gizmo” from the same or a different data source 604, 614, 624. Likewise, the nomenclature data structure 644 may relate a term such as “125V20 A” found in one data source 604, 614, 624, with a term such as “20 amps/125V” found in the same or another data source 604, 614, 624. In other words, the nomenclature data structure 644 may derive a relation or relationship between identifiers, characteristics, and/or other data related to like components, facility items, characteristics, features, etc. found in the various data sources 604, 614, 624

The UMS data 624, in particular, may contain data that is not related to the facility, but which may become related to the facility. By way of example without limitation, the UMS data 624 may comprise a library of electrical components which may or may not be installed to, or even installable to the facility. The UMS, in transforming the data acquired from the various sources 604, 614, 624, to generate a proposal, may select some electrical components from the library of electrical components to incorporate into a proposal for the facility based, at least in part, on the data structuring and normalizing 636. By way of a related and non-limiting example, the UMS may comprise data of the same sorts as acquired from the various data sources 604, 614, 624, but related to one or more different facilities. The UMS may compare various data from the data sources 604, 614, 624 for the facility with appropriate data from other facilities in order to assess the viability and utility of incorporating particular components in a proposal for the facility. The comparison of data from one or more other facilities may be accomplished while ensuring any proprietary information is not comprised.

From the data structuring and normalizing 636, the UMS may begin 646 to prioritize 648 elements of a proposal for the facility. The UMS performs project identification 650. Project identification 650 comprises identifying a solution type 652, cost estimates 654, ROI(s) 656, and precision estimates 658. The solution type 652 represents the nature of the solution generated by the UMS based on the transformation accomplished through data structuring and normalizing 636 of the data from the various data sources 604, 614, 624. A nature of a solution may, for example, comprise replacing components of a single system, or replacing multiple systems completely, a combination of replacing some components and wholly replacing one or more systems, etc. For purposes of the present disclosure, “replacement” includes such concepts as retrofit, refit, upgrade, new-install, etc. A system replacement may comprise removal of a system (or multiple systems) and installing a replacement system (or multiple replacement systems) wherein the replacement system(s) may be one or more of newer, more compact, more efficient, less expensive to operate, etc.

Additionally, through the transformation of the data structuring and normalizing 636, the UMS may determine particular components to use in a proposal, along with a number and arrangement of the components. Furthermore, the UMS may ascertain a cost of acquiring and installing each of the components, whereby a cost of implementing a proposal can be determined. The cost of implementation may be reflected in the cost estimates 654. The cost estimates 654 comprise granular data, and may be rendered to a user at the granular level, or at an overall level, or at any intermediate level. Along with the cost estimates 654, the UMS may further calculate one or more ROIs 656 based on the proposal. In a first instance, the UMS may calculate an ROI 656 based on implementing no proposal. In a second instance, the UMS may calculate an ROI 656 based on implementing the complete proposal generated by the UMS. In another instance, the UMS may calculate an ROI 656 based on partial implementation of the proposal. Furthermore, ROIs 656 may be calculated at particular intervals in the future. Additionally, the UMS may generate alternatives wherein a proposal comprises selecting from a plurality of options, such as components of a first type and components of a second type, and the UMS may calculate ROIs 656 based on each alternative within the proposal. Similarly, the UMS may generate a plurality of proposals for the facility, and may calculate ROIs 656 based on each proposal of the plurality of proposals. When combined with maturity of technology, the ROIs 656 calculated by the UMS may assist an appropriate decisionmaker to assess the ROIs in light of risk acceptance or aversion in order to select a proposal.

Through transformation of the data during the data structuring and normalizing 636, the UMS is able to generate precision estimates 658 for the proposal, or for each proposal of a plurality of proposals for the facility. A precision estimate 658 may comprise granular data for each component, such as cost of acquisition, cost of installation, cost of operation; and may further comprise any ancillary costs (e.g., licensing, permitting, etc.) whereby the precision estimate 658 reflects an accurate cost for implementation of the particular proposal, and for operation of the facility following implementation of the proposal.

Once the project identification 650 is complete, the UMS may apply, or permit a user to apply 660 user filters 662, which represents a second phase of prioritizing 648. The user filters 662 comprise budget filters 664, technology maturity filters 666, ROI(s) filters 668, and occupant goals filters 670. The budget filters 664 may allow rendering of particularized data related to budgetary concerns. The budget filters 664 may be applied at varying levels of granularity whereby an appropriate decisionmaker may view budget information based on various aspects of the proposal. By way of non-limiting example, a budget filter 664 to permit rendering of human-related costs (e.g., labor costs, liability insurance costs, personnel costs by role, etc.), rendering of component costs by system (e.g., computing systems, HVAC systems, electrical systems, etc.), administrative costs (e.g., permitting, licensing, accounting, etc.), and more. The technology maturity filters 666 may permit rendering of a proposal, or portions of a proposal based on a degree to which particular technologies within the proposal have achieved manufacturer's performance expectations, market penetration, market compliance, etc. In one embodiment, the technology maturity filters 666 may be configurable to render all proposed technologies based on a particular degree of maturity. In one embodiment, the technology maturity filters 666 may be configurable to render all proposed technologies of the proposal along with an indicator of maturity. The technology maturity filters 666 and the budget filters 664, in one embodiment, may be relatable whereby budgetary aspects of the proposal may be rendered by selection of particular technology maturity.

In one embodiment, the ROI(s) filters 668 may be configurable to render a variety of ROIs to assist an appropriate decisionmaker in choosing to implement a proposal generated by the UMS. For example, in one configuration, an ROI filter 668 may render the current value and future values of the facility without implementation of a proposal, and, in another configuration, to render current and future values of the facility based on full implementation of a proposal. The ROI(s) filters 668 may be further configurable to render various ROI(s) based on different costs of money scenarios, different completion dates, utility incentives and/or rebates, value of a utility as a unit of exchange, etc. The ROI(s) filters 668 may be further configurable to the particular user, e.g., an owner of the facility, a lease holder, an occupant, an investor, etc.

The occupant goals filters 670 may permit rendering of aspects of the proposal based on objectives of occupants. For purposes of the present disclosure, the term “occupant” encompasses any form of legal ownership or legal occupancy, e.g., owner in fee simple, owner-in-part in the entirety, lease holder, sublet, etc. Since the objectives of an occupant may vary by the nature of occupancy or ownership, the occupant goals filters 670 may permit rendering of aspects of the proposal based on the particular occupant's nature of ownership or occupancy. In other words, an owner of the facility may be interested in a 10-year ROI, while a lease holder may be interested in net costs over a 3-year lease term, etc. Furthermore, each occupant's objectives may be served by a particular alternative in a proposal, or an alternate proposal.

An ROI goal of an owner or occupant may take one (or more) of many forms. Some examples, without limitation, may be a particular financial return on investment, an improvement in customer satisfaction, an increase in employee satisfaction, a targeted ambient lighting configuration, a carbon footprint offset goal, improved ventilation, etc. Necessarily, a calculation in ROI must consider not only the related expenses, but the value to the owner, occupant, other decision maker, etc. of the facility in terms related to the nature of the objective or goals of the owner, occupant, other decision maker, etc. By way of a more particularized but not limiting example, an objective of an owner may be to improve occupant perception of the facility, and may be targeted by adding water features to enhance the occupant experience and the experience of the occupant's clients/customers. A value proposition may take the form of a return on investment and necessarily relates value lost and value gained. Value lost may comprise removal of an installed feature to make room for the water features, loss of positive perception which resulted from the feature to be removed, components and fixtures of the water features, plumbing routing for the water features (in and out), installation costs, maintenance costs, etc. Value gained may comprise loss of any negative perception which resulted from the feature to be removed, positive perception and experience of customers of the occupant, positive perception and experience of employees or the customers, increased revenue for the occupant, community perception of the facility and/or facility owner, etc., increased revenue, lower expenses, cash flow, or profit, etc. A simpler example of the value lost/value gained return on investment may be found in comparing the costs of changing to a new lighting system (e.g., an LED-based lighting system replacing an older fluorescent lighting system) wherein the expense of acquiring the new lighting system, removal of the old lighting system and installation of the new lighting system is compared to a cost saving over time from reduced power consumption and reduced maintenance (and may bear a further benefit of improved lighting generally or specifically). The occupant goals filters 670 may permit rendering of a proposal, or aspect of a proposal, or alternate proposals based on the objectives of the various occupants and owner of the facility.

The user filters 662 enable 672 UMS implementation 674, representing a second phase of the execution 634 element of the UMS 101. The UMS implementation 674 comprises marketing 676, installation 678, and operation 680. The marketing 676 comprises performance of renderings of data described above in a form suitable for each user of the UMS. More particularly, the marketing 676 comprises interfacing with contractors and vendors (see the contractors and vendors 118x in FIGS. 1A and 1B) and appropriate decision makers. The contractors and vendors 118x may use the marketing 676 to facilitate acquisition of components for installation in accordance with the proposal, to confirm installation schedules(s), as well as to indicate to the UMS progress of implementation of the proposal. By way of non-limiting example, the first contractor 118c may employ the marketing 676 in acquiring components, equipment, labor, etc., to confirm installation schedule(s), or to request modification of an installation schedule if, e.g., some components are delayed in delivery; and may further employ the marketing 676 to indicate to the UMS progress in completing installation. The UMS, as described above, may employ updates in progress of completion to update the status of the proposal whereby each user may become apprised of the progress. Extending the foregoing example, when the second contractor 118d is contracted to perform an installation that is dependent on an installation by the first contractor 118c, the second contractor 118d may become apprised via the marketing 676 of readiness to begin work. The marketing 676 may also serve to provide a prospectus (see the prospectus 116 in FIG. 1A) for an appropriate decisionmaker whereby the appropriate decisionmaker may become sufficiently informed to accept the proposal. The prospectus 116, based on the transformation of data occurring principally at the data structuring and normalizing 636, may become configured to present the proposal, including variations of the proposal or alternate proposals in sufficient detail, even to a granular level, to enable the appropriate decisionmaker to adopt a proposal for implementation.

The installation 678 may enable updating the digital twin, which, in turn, may enable updating each child digital twin (see the digital twin 130 and child digital twins 130c, 130d in FIG. 1B) whereby each user may become informed of the current state of progress or completion of the proposal. Furthermore, the installation 678 may access the relational data structures (see the relational data structures 140 in FIG. 1B) and/or other portions of the UMS, to facilitate rendering the current state of the facility at any time; and may update the relational data structures 140 in real time or near real time whereby each the relational data structures of each user (see the relational data structures 140c-140e in FIG. 1B) may be updated. The installation 678 may acquire data regarding completion (or partial completion), etc., via input from the contractors and vendors 118x.

The operation 680 within the UMS implementation 674 may acquire data regarding the completion (or partial completion) of the proposal whereby the UMS may begin to acquire data about the performance of installed components. The operation 680, in particular, on an ongoing basis may acquire data regarding installed components over time, and may comprise data regarding resource consumption (e.g., electrical power consumption), failure data, etc. The operation 680 may enable the UMS to develop ATBF as installed to the facility, better or more comprehensive technology maturity data, etc., whereby the UMS may perform comparative analyses with regard to future proposals for the facility or other facilities.

The UMS implementation 674 provides 682 input for the UMS data 624, establishing a circular logic 602 for the UMS. In particular, the circular logic 602 enables the UMS to provide forward-looking data regarding the facility, such as may relate to maintenance, ROI(s), property value over time, a future proposal for the facility, etc. The circular logic 602 may further enable the UMS in developing proposals for other facilities having at least some characteristics comparable to the facility, the value of a utility resource as a unit of exchange, providing bases for assessing technology maturity and assisting technology maturation by identifying appropriate candidates for installation of a particular technology, etc.

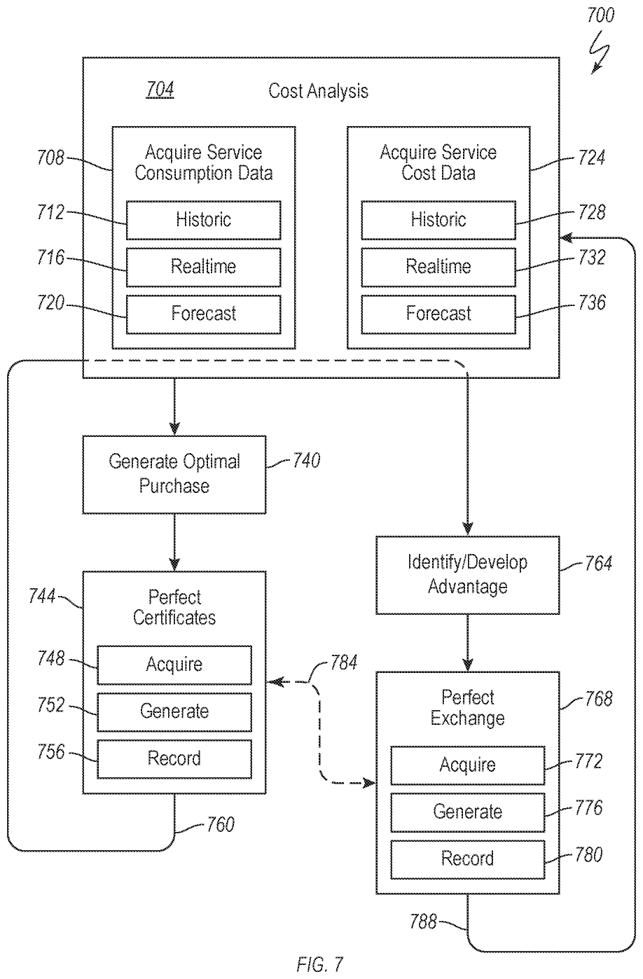

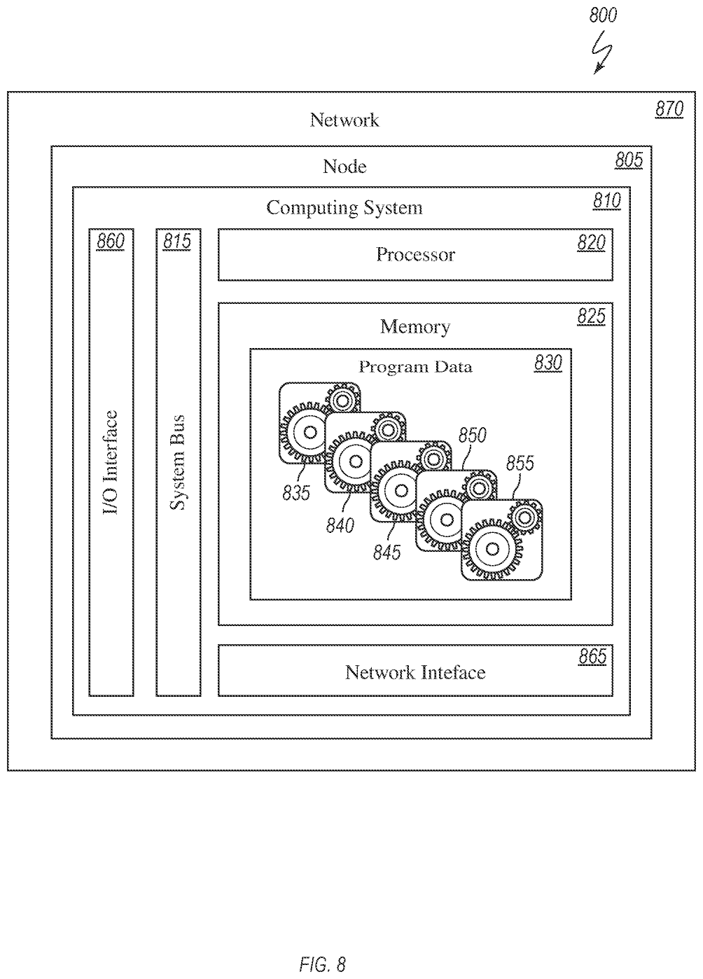

FIG. 7 is a flowchart illustrating a method 700 of a UMS, such as the UMSs 101, 401, 402 of FIGS. 1A-6, for handling a service as a commodity, according to an embodiment of the present disclosure. The method 700 may be employed in parallel with the methods 500, 600 of FIGS. 5 and 6. A cost analysis 704 is performed using data acquired via the methods 500, 600 of FIGS. 5 and 6. The cost analysis 704 comprises acquiring service consumption data 708 and acquiring service cost data 724 to generate an optimal purchase 740 of a particular service. One or more statistical or other algorithmic based methods may be used to generate the purchase, including artificial intelligence and/or machine learning algorithms. A neural network may be utilized in the generation process and the neural network may be modified or enhanced based on prior outcomes. The service consumption data 708 comprises historical data 712, real time data 716, and forecast data 720. The historical data 712 relates to the consumption of the particular service by the building (see the building 10 in FIGS. 1A-4) over a relevant period of time. The real time data 716 comprises current usage data relating to consumption of the particular service by the building 10 as it is presently configured, and considers all presently installed relevant components. The forecast data 720 comprises data reflecting anticipated consumption of a particular service, and may consider, in addition to currently installed relevant components, any planned replacements or upgrades. The forecast data 720 may generate consumption data for particular periods, such as, e.g., work week cycle, 30-day cycle, quarterly cycle, annual cycle, 3-year cycle, etc.

The service cost data 724 comprises historic data 728, real time data 732, and forecast data 736. The historic data 728 comprises data regarding the cost of acquiring a service, considering at least a quantity of the service acquired, and components of the building 10 when the service was used at historical cost level. The historic data 728 may further comprise regional factors, such as, e.g., weather considerations, service provider status and buildout, disruptions in the region, disruption outside the region but having an effect on the regional service capacity, delivery capacity, etc. The real time data 732 comprises data regarding the cost of service at the present, and may consider factors similar to those related to historic data 728 which may be affecting current service cost. The forecast data 736 relates to prediction of service cost at a future date, or in a future period. The forecast data 736 may also consider factors similar to those employed for the historic data 728 and/or the real time data 732. The forecast data 736 may further consider future planned upgrades and/or replacements affecting cost of service. The forecast data 736 may generate cost forecasts for particular times in the future, or periods of time in the future. Cost analysis 704 may execute recursively, may execute at set time intervals, may execute upon the occurrence of a triggering event, or any combination of these.

Based upon the cost analysis 704, the method 700 may generate an optimal purchase 740. The optimal purchase 740 may comprise a proposal to purchase an amount of future production of service (service-as-a-commodity) from a service provider (see the service provider 20 in FIGS. 3 and 4). The optimal purchase 740 may, for example, propose purchasing 1,000 megawatts of electrical power for future consumption to be purchased at a time when the price of the electrical power is forecast to be lower than the price may be at the time of consumption, thereby generating a cost-saving. In other words, based on historic data 712, 728, the method 700 may identify a seasonal price reduction which may allow purchasing future production at a lower cost than may be available in the current “cash and carry” model.

Upon approval (such as, e.g., from an owner, operator, or manager of the building 10), a token may be perfected 744. Token perfection 744 comprises acquiring 748 an electronic token and recording 756 the token. Acquiring 748 the token may comprise tender of an offer to the service provider 20 for the acquisition of service-as-a-commodity (purchase of future service), acceptance, render of payment and delivery of an electronic token representing an ownership interest in future production of service. Recording 756 of the token may comprising inserting the token in a block of a blockchain, thereby creating a trustless and immutable record of the transaction. Token perfection 744 may further comprise converting the electronic token provided by the service provider 20 to an electronic exchange medium, or generating 752 an electronic token exchangeable in an appropriate electronic marketplace.

Following token perfection 744, recursion 760 to cost analysis 704 permits iterating through the cost analysis 704. Iterating through cost analysis 704 may permit identifying or developing an advantage 764 relative to the service-as-a-commodity. An advantage is an instance in which an opportunity may be created or employed whereby a further purchase of service-as-a-commodity, sale of service-as-a-commodity or portion thereof, or exchange of service-as-a-commodity or portion thereof creates an income to, or reduces an expense against the building 10. By way of example without limitation, a component of the building 10 may reach EOL or otherwise need replacement. The UMS 101 may, in performing the methods 500, 600 of FIGS. 5 and 6, develop an upgrade or replacement plan which produces a reduced demand for the particular service-as-a-commodity. An advantage may be developed in determining to sell or exchange the service-as-a-commodity or portion thereof, or in extending the period of time until the service-as-a-commodity is consumed. As a further non-limiting example, a new service provider may enter the market, and the new service provider, or the original service provider 20, or both, may offer incentives to, respectively, acquire or retain the building 10 as a client. In this instance, development of the advantage 764 may entail purchasing service-as-a-commodity from one or both service providers. One or more statistical or other algorithmic based methods may be used in the development of the advantage 764, including artificial intelligence and/or machine learning algorithms. A neural network may be utilized and the neural network may be modified or enhanced based on the outcome.

Once an advantage has been identified and developed 764, an exchange may be perfected 768. An exchange may be a purchase, sale, or trade of a service-as-a-commodity or portion thereof. More particularly, an exchange occurs when an ownership interest in a service-as-a-commodity may be purchased, sold, or engaged in a trade. Perfecting the exchange 768 may comprise acquiring 772 a consideration, generating 776 a token (e.g., an electronic token) representative of the exchange, and recording 780 the token. Acquiring 772 a consideration may comprise receiving payment for service-as-a-commodity sold by the building 10, or receiving a representation of ownership interest in a service-as-a-commodity purchased by the building. A trade of commodities and/or service-as-a-commodity is also within the scope of acquiring 772 a consideration. Generating 776 a token may comprise converting a token received into another token suitable for further exchange or redemption against the service-as-a-commodity. The exchange is recorded 780 to a block of a blockchain to create a trustless and immutable record of the exchange. Furthermore, for purposes of the disclosure, redemption of token against a service-as-a-commodity (presenting the token to the service provider 20 as current payment) is also an exchange that may be perfected 768 and recorded 780.

Once an advantage has been developed 764 and an exchange perfected 768, recursion 788 to cost analysis 704 takes place to permit iteration through the method 700. Notably, portions of perfecting tokens 744 and perfecting exchange 768 may be shared. More particularly, the process represented by acquire 748 and acquire 772 may be the same, as may be the process for generate 752 and generate 776, and the process for record 756 and 780. Accordingly, data may move 784 between the respective modules, provided that perfecting an exchange 768 produces, essentially, an “update” to the token perfected 744 earlier in the method 700.

FIG. 8 is a system diagram fora portion of a UMS computing system 800 for the UMS 700 of FIG. 7, and having a node 805, according to an embodiment of the present disclosure. The node 805 may be a meter, a submeter, a SCADA device, an Internet-of-Things (IoT) device, or other small computing device. The node 805 may be a point-of-service device capable of recording and reporting delivery of service to a consumer building or facility (e.g., the building 10 of FIG. 1). The node 805 comprises a computing system 810. The computing system 810 includes a system bus 815, one or more processors 820, an electronic memory (memory) 825, an input/output (i/o) interface 860, and a network interface 865.

The computing system 810 may be a comprise a general-purpose computer, or a purpose-built computer. The one or more processors 820 may include one or more general purpose devices, such as an Intel®, AMD®, or other standard microprocessor. The one or more processors 820 may include a special purpose processing device, such as ASIC, SoC, SiP, FPGA, PAL, PLA, FPLA, PLD, or other customized or programmable device. The one or more processors 820 may perform distributed (e.g., parallel) processing to execute or otherwise implement functionalities of the present embodiments. The one or more processors 820 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth. The electronic memory 825 may include static RAM, dynamic RAM, flash memory, one or more flip-flops, ROM, CD-ROM, DVD, disk, tape, or magnetic, optical, or other computer storage medium, and includes at least a non-volatile storage device capable of storing machine readable and executable instructions. The electronic memory 825 may include a plurality of program modules 835-855 and a program data 830. The electronic memory 825 may be local to the computing system 810 or may be remote from the computing system 810 and/or distributed over a network.

The program modules 835-855 may include all or portions of other elements of the system 800. The program modules 835-855 may run multiple operations concurrently or in parallel by or on the one or more processors 820. In some embodiments, portions of the disclosed modules, components, and/or facilities are embodied as executable instructions embodied in hardware or in firmware, or stored on a non-transitory, machine-readable storage medium. The instructions may comprise computer program code that, when executed by a processor and/or computing device, cause a computing system to implement certain processing steps, procedures, and/or operations, as disclosed herein. The modules, components, and/or facilities disclosed herein, may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like.

The program data 830 stored on the electronic memory 825 may include data generated by the system 800, such as by the program modules 835-855 or other modules. The stored program data 830 may be organized as one or more databases.

The I/O interface 860 may facilitate interfacing with one or more input devices and/or one or more output devices. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The network interface 865 may facilitate communication with other computing devices and/or networks 805, such as the Internet and/or other computing and/or communications networks. The network interface 865 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the network interface 865 may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth. The network interface 865 may be configured or configurable to employ an ISO/IEC 20992 or similar standard lightweight transport protocol (e.g., Message Queuing Telemetry Transport (MQTT)). The system bus 815 may facilitate communication and/or interaction between the various components of the system 800, including the one or more processors 820, the electronic memory 825, the i/o interface 860, and the network interface 865.

As noted, the system 800 includes various program modules 835-855 (or engines, elements, or components), at least some of which are to implement functionalities of the system 800 and to generate, access, and/or manipulate the program data 830 stored in the electronic memory 825.

The system program modules 835-855 can include a time module 835, a data pack module 840, and one or more modules 845-855 to perform functions particular to the individual node 805. By way of non-limiting example, a node 805 serving as a meter may have a module 845 to monitor, record, and report (e.g., to another module or engine, or to another computing system) a quantity or rate at which a metered service is delivered. Another example may be found in a household refrigerator, which may have a temperature regulation module 850 to regulate temperature(s) within (one or more regions of) a storage compartment of the refrigerator. The present disclosure anticipates a wide variety of devices, e.g., IoT device, meters, submeters, SCADA devices, etc., may serve as a node 805.

The time module 835 may facilitate communication in particular with a time server to ensure the node 805 is synchronized to a standard time, to provide time-based regulation of some communication in order to reduce or prevent communication collisions and other communication failures, and may further provide a time (or a timestamp) to another module, e.g., the data pack module 840. The time module 835 may be configured to continuously update an internal time to enable time recordation between synchronization intervals. In other words, the node 805 may be configured to synchronize the time module 835 with a time server at a fixed interval (e.g., every 5 seconds), and the time module 835 may initiate a time synchronization request, process a time synchronization response, and maintain an internal time during the interval between synchronization cycles.

In one embodiment, the data module 840 may both generate a data pack, and provide data pack validation of a data pack generated at a different node. In one embodiment, the program data 830 may comprise a first data pack module to generate data packs for the node 805, and second data pack module to provide data pack validation of data packs of other nodes. The data pack module 840 may receive data from one or more of the modules 845 et seq., and a current time from the time module 835. The data received from the one or more modules 845 et seq. may represent a quantity of a service delivered at or through the node. The data pack module 840 may combine the data from the one or more modules 845 et seq. with the current time from the time module 835 to generate a data pack that bears a timestamp relatable to the data received from the one or more modules 845 et seq. The data pack module 840 may also generate a hash based on the combined data and timestamp, according to a standard hashing algorithm.

The node 805 may be one of a plurality of nodes that may form a cohort, the nodes of which are in communication with each other for the purpose of exchanging and validating data packs from each of member node of the cohort. The nodes of the cohort may elect a coordinator node. The coordinator node may be configured to ensure each member node of the cohort receives each data pack from each member node, and reports a result. Network latency and outages may be accounted for, and the cohort may reconfigure around a missing node, or around a newly rejoining (or newly joining) node. When the node 805 receives a data pack from another node of the cohort, the data pack module 840 may verify the timestamp associated with the data pack. Upon verifying the timestamp of the data pack, the node 805 votes to accept the data pack. If the node 805 finds a discrepancy in with the timestamp, the node 805 votes to reject the data pack. When each member node of the cohort has voted, the particular data pack is accepted or rejected according to the consensus of the member nodes of the cohort. Each accepted data pack is bundled with at least one other accepted data pack and then passed to a succeeding cohort, the succeeding cohort to similarly validate each received data pack by verifying the timestamps. The member nodes of the succeeding cohort may bundle the accepted data packs from the previous cohort with accepted data packs of the current succeeding cohort. The data packs of the two cohorts are ordered and timestamped, thereby forming a data chain. The data chain may then be passed to a next succeeding cohort where the process is repeated. Validation of each data pack by verifying the timestamp associated to each data pack is an energy efficient and rapid manner of creating an immutable and trustless record of the data packs from each node in the UMS system. One or more data packs may be associated to a token (as described elsewhere herein), whereby the one or more data packs represent production of a service-as-a-commodity, delivery of the service-as-a-commodity, consumption of the service-as-a-commodity, exchange of the service-as-a-commodity, etc.

While the present disclosure has explicitly described embodiments related to a building 10, the disclosure anticipates that a facility for which proposals may be generated under an embodiment may entail a facility with more than one structure. Furthermore, the one or more structures situated upon a physical site, may include that one or more structures that may be manmade artifices other than a building (e.g., a power transmission structure, a water moving or lifting structure, a lighting facility for an outdoor area of the site, an athletic field with its accompanying accoutrement, etc.). Stated otherwise, the facility may comprise one or more structures and a site upon which the one or more structures are constructed.

### EXAMPLES

Some examples of embodiments of the present disclosure are provided below.

Example 1. A system of facility management comprising an interface to a communication network to communicate over a network with a facility; a non-transitory memory; one or more processors in electrical communication with the memory and to receive and transmit data via the communication interface; a digital representation generation engine comprising hardware logic to generate an accurate digital representation of the facility, including to: receive map data of a facility, the map data including plan data providing a layout of the facility and relevant item data that provides facility items, including a location of each facility item within the layout of the facility; receive historical operational data providing historical operating conditions of the facility, including the one or more facility items; and convert the map data and historical operational data into the digital representation of the facility; and a digital representation operation engine comprising hardware logic to: receive live operational data providing present operating conditions of the facility; update the digital representation of the facility with the present operating conditions of the facility to ensure the digital representation continues to accurately represent the facility; and provide a digital, three-dimensional (3D) visualization of the facility to a user to present to the user the layout of the facility, the one or more facility items, and operating conditions of the facility.

Example 2. The system of example 1, wherein the facility comprises one or more structures and a site upon which the one or more structures are constructed.

Example 3. The system of example 2, wherein the facility comprises equipment positioned on the site (e.g., external to the structures).

Example 6. The system of example 1, further comprising: a proposal engine to: generate a proposal for the facility, the proposal comprising a set of one or more recommendations each pertaining to one or more corresponding facility items, each recommendation comprising an action to be implemented or performed in relation to the one or more corresponding facility items and a value proposition for implementing or performing the action; and transmit the proposal to a human facility point of contact.

Example 7. The system of example 6, further comprising: an installation management engine to: receive approval of the proposal from the human facility point of contact; instruct implementation of the action of one or more recommendations of the set of one or more recommendations of the proposal, according to the approval of the proposal received from the point of contact for the facility; and receive verification of implementation of the action of the one or more recommendations of the set of one or more recommendations of the proposal, wherein the digital representations operational engine updates the digital representation to reflect the implemented action of the one or more recommendations of the set of one or more recommendations of the proposal.

Example 8. The system of example 7, wherein the operating conditions include one of an actual operational cost of facility operation and data from which the actual operational cost can be derived, wherein the proposal engine is further configured to: compare the actual operational cost of facility operation to the value proposition for implementing the corresponding action; and one or more of: generate a subsequent proposal based in part on information from the comparing the actual operational cost of facility operation to the value proposition for implementing the action to improve a recommendation, including a value proposition for performing or implementing an action, in the subsequent proposal; and transmit a report to the point of contact for the facility providing a result of the comparison of the actual operational cost of facility operation to the value proposition for implementing the corresponding action.

Example 9. The system of example 6, wherein the action of a recommendation comprises one or more of improving, upgrading, replacing, retrofitting, modifying, and maintaining the facility item to which the recommendation pertains.

Example 10. The system of example 1, further comprising: an interface engine to provide a user interface to a client computing device, the user interface providing functionality to: receive, via the user interface, additional relevant item data to revise/update/augment digital representations of facility items to update the digital representation of the facility; present to a user the visualization of the facility; access live product information from one or more vendors through a marketplace; and select a product to be included as one of a new facility item or upgrade facility item in a proposal for the facility.

Example 11. The system of example 10, further comprising a product recommendation engine to identify recommended products to be incorporated as a facility item in the facility.

Example 12. The system of example 1, wherein at least one facility item of the facility items comprises facility equipment relevant to operation of the facility, where the historical operating conditions and present operating conditions include operating condition of the facility equipment.

Example 13. A computer implemented method of managing a facility, comprising: receiving map data of an existing facility (i.e., a place comprising at least a physical structure constructed and/or installed for an activity or to serve a function), the map data including plan data providing a layout of the facility and relevant item data for one or more facility items, including a location of each of the one or more facility items within the layout of the facility; receiving historical operational data (e.g., usage; hours of operation, control schemes, energy consumption) providing historical operating conditions of the facility (potentially up to the present moment), including the one or more facility items; converting the map data and historical operational data into a digital representation of the facility; receiving live operational data providing present (or current or updated) operating conditions of the facility; updating the digital representation of the facility with the present operating conditions of the facility (and the new designed facility item) to ensure the digital representation continues to provide accurate representation of the facility; and providing a digital, three-dimensional (3D) visualization of the facility to a user, the visualization generated from the digital representation, the visualization to present or render to the user the layout of the facility, the one or more facility items, and operating conditions of the facility.

Example 14. The method of example 13, wherein the relevant item data for the one or more facility items further includes specification (i.e., equipment specifications) for at least the one or more facility items that comprise operation equipment, the specification provided by a manufacturer of each facility item to describe its physical and operational characteristics (i.e., how the facility item is designed or intended to perform/operate).

Example 15. The method of example 13, wherein the relevant item data for the one or more facility items further includes integrations for at least the one or more facility items that comprise operational equipment, the integrations of each facility item to describe how it integrate to other facility items.

Example 16. The method of example 13, wherein the one or more facility items include both operational facility items (i.e. operate to perform a function, e.g., HVAC, lighting,) and nonoperational facility items (i.e., do not operate, e.g., window, tile flooring, a staircase).

Example 17. The method of example 13, wherein the facility comprises one or more structures and a site upon which the one or more structures are constructed.

Example 18. The method of example 13, wherein the layout of the facility comprises a floor plan of a structure of the facility.

Example 19. The method of example 18, wherein the layout of the facility further comprises a reflected ceiling plan of the structure.

Example 20. The method of example 13, further comprising: generating a proposal for the facility, the proposal comprising a set of one or more recommendations each pertaining to one or more corresponding facility items, each recommendation comprising an action to be performed or implemented in relation to the one or more corresponding facility items and a value proposition for performing or implementing the action; and transmitting the proposal to a human point of contact for the facility.

Example 21. The method of example 20, further comprising: receiving approval of the proposal from the human point of contact of the facility; and instructing performance or implementation of the action of one or more recommendations of the set of one or more recommendations of the proposal, according to the approval of the proposal received from the point of contact for the facility.

Example 22. The method of example 21, further comprising: receiving verification (e.g., user input (from an installation contractor, from the point of contact, etc.)) of performance of the action of the one or more recommendations of the set of one or more recommendations of the proposal, wherein updating the digital representation includes updating the digital representation to reflect the performed or implemented action of the one or more recommendations of the set of one or more recommendations of the proposal.

Example 23. The method of example 22, wherein the operating conditions include one of an actual operational cost of facility operation and data from which the actual operational cost of facility operation can be derived, the method further comprising: comparing the actual operational cost of facility operation to the value proposition for performing or implementing the corresponding action; and one or more of: generating a subsequent proposal based in part on information from the comparing the actual operational cost of facility operation to the value proposition for performing or implementing the action to improve a recommendation, including a value proposition for performing implementing an action, in the subsequent proposal; and transmitting a report to the point of contact for the facility providing a result of the comparing.

Example 24. The method of example 23, wherein the actual operational cost of facility operation comprises a sum of operation costs of all facility items.

Example 25. The method of example 23, wherein the actual operational cost of facility operation comprises an operational cost of the one or more corresponding facility items of the proposal.

Example 26. The method of example 23, wherein the comparing comprises normalizing one or more of the actual operational cost of facility operation and the value proposition for performing or implementing the corresponding action to compare either a total actual operational cost of the facility (i.e. a sum of operational costs of all facility items) to a total anticipated operational cost of the facility (i.e., a sum of operational costs of all facility items with the value proposition integrated) OR an actual operational cost of the corresponding facility items to which pertains the implemented actions to the value proposition for performing the action.

Example 27. The method of example 20, wherein the action of a recommendation comprises one or more of improving, upgrading, replacing, retrofitting, modifying, and maintaining the facility item to which the recommendation pertains.

Example 28. The method of example 20, wherein the one or more corresponding facility items includes one or more of an operational facility item and a nonoperational facility item.

Example 29. The method of example 20, wherein the action comprises doing nothing (e.g., because the facility item is presently performing or otherwise within an optimal or desired state).

Example 30. The method of example 13, further comprising: providing a user interface to a client computing device (e.g., tablet, smartphone, laptop, etc.) over a communication network, the user interface providing functionality to: receive, via the user interface, additional relevant item data to revise/update/augment digital representations of facility items to update the digital representation of the facility; present to a user the three-dimensional (3D) visualization of the facility; access live product information from one or more vendors through a marketplace; view one or more recommended products to be incorporated as a facility item in the facility; and select a product to be included as one of a new facility item or upgrade facility item in a proposal for the facility.

Example 31. The method of example 13, wherein a facility item of the one or more facility items comprises facility equipment relevant to operation of the facility, where the historical operating conditions and present operating conditions include operating conditions of the facility equipment.

Example 32. The method of example 13, wherein the one or more facility items include one or more of areas of interest and facility equipment.

Example 33. The method example 13, wherein the one or more facility equipment includes fixtures (e.g., a lighting fixture, router, photovoltaic panel—i.e., fixtures are an example of equipment).

Example 34. The method of example 13, wherein the relevant item data for the one or more facility items further includes operational system information describing a collection of facility items performing an operation of a facility (e.g., HVAC system).

Example 35. The method of example 13, further comprising: transforming the digital representation of the facility into a design stage digital model of the facility (e.g., BIM).

Example 36. The method of example 13, further comprising: generating the visualization of the facility from the digital representation and/or the digital model.

Example 37. The method of example 35, further comprising: generating the visualization of the facility from the digital representation and/or the digital model.

Example 38. A system of facility management, comprising: a communication network interface to communicate over a network with a facility; one or more processors to receive and transmit data via the communication interface; a non-transitory memory having stored thereon instructions that, when executed by the one or more processors, cause the processor to perform operations to enhance facility management, the operations to receive map data of a facility, the map data including plan data providing a layout of the facility and relevant item data for one or more facility items, including a location of each of the one or more facility items within the layout of the facility; receive historical operational data providing historical operating conditions of the facility, including the one or more facility items; convert the map data and historical operational data into a digital representation of the facility; receive live operational data providing present operating conditions of the facility; update the digital representation of the facility with the present operating conditions of the facility to ensure the digital representation continues to provide an accurate representation of the facility; and provide a digital, three-dimensional (3D) visualization of the facility to a user, the visualization generated from the digital representation, the visualization to present or render to the user the layout of the facility, the one or more facility items, and operating conditions of the facility.

Example 39. A computer implemented method of managing a facility, comprising: receiving map data of an existing facility, including a site upon which one or more structures of the facility are built, the map data including plan data of the facility providing a layout of the facility and relevant item data for facility items relevant to operation of the facility, the relevant item data including a location of each of the facility items within the layout of the facility, the facility items comprising operational facility items and non-operational items and including areas of interest and facility equipment; receiving historical operational data providing historical operating conditions of the facility equipment; converting the map data and historical operational data into a digital representation of the facility; providing a visualization of the facility to a user, the visualization generated from the digital representation, the visualization presenting a floor plan, a reflected ceiling plan, the facility items, and the operating conditions of the facility equipment; receiving live operational data providing current operating conditions of the facility equipment; updating the digital representation of the facility with the current operating conditions of the facility equipment; and providing a revised visualization of the facility according to the current operating conditions of the facility equipment

Example 40. The method of example 39, further comprising: generating a proposal for the facility, the proposal comprising a set of one or more recommendations each pertaining to one or more corresponding facility items, each recommendation comprising an action to be implemented in relation to the one or more corresponding facility items and a value proposition for implementing the action; transmitting the proposal to a facility point of contact; receiving approval of the proposal from the facility point of contact; instructing performance of the action of one or more recommendations of the set of one or more recommendations of the proposal, according to the approval of the proposal received from the facility point of contact; and receiving verification of performance of the action of the one or more recommendations of the set of one or more recommendations of the proposal, wherein updating the digital representation includes updating the digital representation to reflect the implemented action of the one or more recommendations of the set of one or more recommendations of the proposal.

Example 41. A method of providing a digital representation of a facility, comprising: receiving map data of a facility, the map data including plan data providing a layout of the facility and relevant item data of facility items, including a location of each of the facility items within the layout of the facility; receiving operational data providing operating conditions of the facility, including the facility items, generating an accurate digital representation of the facility based on the map data and the operational data; receiving ongoing operational data providing current operating conditions of the facility; maintaining accuracy of the digital representation of the facility based on the current operating conditions of the facility provided in the ongoing operational data; providing a visualization of the facility to a user, the visualization generated from the digital representation, the visualization to present to the user the layout of the facility, the facility items, and current operating conditions of the facility.

Example 42. A computer implemented method of managing facility comprising: receiving live operational data providing current operating conditions of facility equipment; updating a digital representation of the facility with the current operating conditions of the facility with the current operating condition of the facility equipment; and generating a revised visualization of the facility according to the current operating conditions of the facility equipment; wherein the digital representation is obtained through conversion, prior to receiving the live operation data, of: map data of the facility including plan data of the facility and relevant item data that provides facility items relevant to operation of the facility; and historical operation data providing historical operating conditions of the facility equipment.

Example 42. The system of example 1, wherein the facility receives a service provided by a service provider against a payment for the service provided.

Example 43. The system of example 42, wherein the facility comprises a service generation means configured to generate a service, and whereby at least a portion of a service demand of the facility is met through the service generation.

Example 44. The system of example 43, wherein the facility sells (or otherwise delivers) to the service provider a portion of the service generated by the service generation means, and wherein the service provider renders compensation to the facility in consideration for the portion of the service delivered to the service provider.

Example 45. The system of example 44, wherein one of a purchase, a redemption, and a trade of a service is represented by an electronic entry to a blockchain.

Example 46. The system of example 44, wherein the facility provides to another facility a portion of the service generated by the service generation means against compensation.

Example 47. The system of example 46, wherein one of a purchase, a redemption, and a trade of a service is represented by an electronic entry to a blockchain.

Example 48. The method of example 13, wherein the method of managing a facility further comprises acquiring a cost of service provision based on at least historical cost information and historical facility component data, current cost information and current facility component information, and forecast cost information and forecast facility component information.

Example 49. The method of example 48, wherein the cost of service provision provides a basis for purchasing (pre-purchasing) a service from a service provider.

Example 50. The method of example 49, wherein facility comprises a means of generating a portion of the service provided by the service provider.

Example 51. The method of example 50, wherein the facility delivers to the service provider a portion of the service generated by the means of generating a portion of the service, and the service provider compensates the facility therefor.

Example 52. The method of example 51, wherein the facility delivers to another facility a portion of the service generated by the means of generating a portion of the service provided by the service provider, and the other facility compensates the facility therefor.

Example 53. The method of example 50, wherein one of delivery of the service to the facility, delivery of the service to the service provider, and delivery of the service to another facility is recorded to a blockchain.

Example 54. A system of facility management comprising: a communication network interface to communicate over a network with a facility; one or more processors; a non-transitory memory having stored thereon instructions that, when executed by the one or more processors, cause the one or more processors to perform operations to enhance facility management to: receive facility data for a target facility of a potential facility project, the facility data including one or more of item data for facility items of the target facility that are relevant to the potential facility project, location data of each facility item within a layout of the target facility, and/or operational data for the target facility; receive candidate component or item data for candidate components relevant to the potential facility project, the candidate components each having one or more meaningful similarities with one or more of the facility items; access a facilities data set including comparable or similar facility data of a plurality of comparable or similar facilities each having one or more meaningful similarities with the target facility, the comparable facility data including item data for facility items of the plurality of comparable facilities, location data of each facility item within a layout of the plurality of comparable facilities, and/or operational data for the plurality of comparable facilities; determine an action for the potential facility project in relation to, or involving one or more of the facility items and one or more of the candidate components; determine a value proposition value for performing or implementing the action based on the facility data for the target facility, the facility data of the plurality of comparable facilities, and the candidate component data; determine an expenditure value for performing or implementing the action based on the facility data for the target facility, the facility data of the plurality of comparable facilities, and the candidate component data; provide a recommendation to a point of contact for the target facility, the recommendation including the action and one or more: the one or more facility items, the one or more candidate components, the value proposition, and the expenditure value.

Example 55. The system of example 54, wherein the instructions further cause the one or more processors to perform operations to calculate a return on investment based on the value proposition value and the expenditure value, wherein the recommendation further includes the return on investment.

Example 56. The system of example 54, wherein the facility comprises one or more structures and a site upon which the one or more structures are constructed.

Example 57. The system of example 56, wherein the facility comprises equipment positioned on the site (e.g., external to the structures).

Example 58. The system of example 54, wherein the comparable facility data further includes outcome data providing information pertaining to an outcome of a completed facility project at a comparable facility, wherein the value proposition value is further determined based on the outcome data.

Example 59. The system of example 54, wherein the value proposition value is determined by providing the facility data for the target facility to an algorithm trained on, or that considers the facility data of the plurality of comparable facilities.

Example 60. The system of example 59, wherein the algorithm comprises a neural network.

Example 61. The system of example 59, wherein the instructions further cause the one or more processors to perform operations to: collect new outcome data following completion of the potential facility project; and modify the algorithm based on the new outcome data.

Example 62. The system of example 54, wherein the expenditure value is determined by providing the facility data for the target facility to an algorithm trained on, or that considers the facility data of the plurality of comparable facilities.

Example 63. The system of example 54, wherein the action is determined by providing the facility data for the target facility to an algorithm trained on, or that considers the facility data of the plurality of comparable facilities.

Example 64. The system of example 54, wherein the instructions further cause the one or more processors to perform operations to: update the facilities data set to include the facility data of the target facility for consideration in future recommendations.

Example 65. The system of example 54, wherein the instructions further cause the one or more processors to perform operations to: receive approval of the recommendation for the target facility; and instruct the action of the recommendation, according to the approval of the recommendation that was received for the target facility.

Example 66. The system of example 65, wherein the instructions further cause the one or more processors to perform operation to: collect new outcome data following completion of the action of the recommendation; and update the facilities data set to include the new outcome data.

Example 67. The system of example 66, wherein one or more of the action, the value proposition value, and the expenditure value is determined by providing the facility data for the target facility to a respective algorithm trained on, or that considers the facility data of the plurality of comparable facilities.

Example 68. The system of example 67, wherein the instructions further cause the one or more processors to perform operations to: alter the algorithm based on the new outcome data.

Example 69. A computer implemented method of providing a facility project recommendation, comprising: receiving facility data for a target facility of a potential project, the facility data including one or more of item data for facility items of the target facility that are relevant to the potential facility project, location data of each facility item within a layout of the target facility, and/or operational data for the target facility; receiving candidate component or item data for candidate components relevant to the potential facility project, the candidate components each having one or more meaningful similarities with one or more of the facility items; accessing a facilities data set including comparable or similar facility data of a plurality of comparable or similar facilities each having one or more meaningful similarities with the target facility, the comparable facility data including item data for facility items of the plurality of comparable facilities, location data of each facility item within a layout of the plurality of comparable facilities, and/or operational data for the plurality of comparable facilities; determining an action for the potential facility project in relation to or involving one or more of the facility items and one or more of the candidate components; determining a value proposition value for performing or implementing the action based on the facility data for the target facility, the facility data of the plurality of comparable facilities, and the candidate component data; determining an expenditure value for performing or implementing the action based on the facility data for the target facility, the facility data of the plurality of comparable facilities, and the candidate component data; calculating a return on investment based on the value proposition value and the expenditure value; providing a recommendation to a point of contact for the target facility, the recommendation including the action, the one or more facility items, the one or more candidate components, and one or more of the value proposition value, the expenditure value, and the return on investment.

Example 70. The method of example 69, wherein the comparable facility data further includes outcome data providing information pertaining to an outcome of a completed facility project at a comparable facility, wherein the value proposition value is further determined based on the outcome data.

Example 71. The method of example 70, wherein the outcome data includes an indication of a change in operational data from before the completed facility project to after the completed facility project.

Example 72. The method of example 71, wherein the outcome data includes a comparison of a value proposition value of a corresponding recommendation of the completed facility project against actual operational data after the completed facility project.

Example 73. The method of example 71, wherein the outcome data includes a comparison of an expenditure value of a corresponding recommendation of the completed facility project against actual operational data after the completed facility project. One or more statistical or other algorithmic based methods may be used to evaluate the relevance, accuracy, and/or precision of the comparison.

Example 74. The method of example 70, wherein the value proposition value is determined by providing the facility data for the target facility to an algorithm trained on or that considers the facility data of the plurality of comparable facilities.

Example 75. The method of example 74, wherein the candidate component data is provided as an input to the algorithm.

Example 76. The method of example 74, wherein the algorithm is implemented as a neural network.

Example 77. The method of example 74, further comprising: collecting new outcome data following completion of the potential facility project; and modifying the algorithm based on the new outcome data.

Example 78. The method of example 70, wherein the expenditure value is determined by providing the facility data for the target facility to an algorithm trained on or that considers the facility data of the plurality of comparable facilities.

Example 79. The method of example 70, wherein the action is determined by providing the facility data for the target facility to an algorithm trained on or that considers the facility data of the plurality of comparable facilities.

Example 80. The method of example 69, further comprising: updating the facilities data set to include the facility data of the target facility for consideration in future recommendations.

Example 81. The method of example 69, further comprising: receiving verification (e.g., user input (from an installation contractor, from the point of contact, etc.)) completion of the action of the recommendation; and updating the facilities data set to reflect the completion of the action of the recommendation.

Example 82. The method of example 69, wherein the facilities data set includes one or more previous recommendations provided to one or more of the plurality of comparable facilities and operational data for the plurality of comparable facilities, wherein the value proposition value is further determined based at least in part on comparing value propositions of the one or more previous recommendations to the operational data for one or more of the plurality of comparable facilities.

Example 83. The method of example 82, wherein the operational data for the plurality of comparable facilities provides operating conditions that include one or more of an actual operational cost of the comparable facilities and data from which the actual operational cost of the comparable facilities can be derived, the method further comprising: comparing the actual operational cost of a comparable facility to a value proposition value for a corresponding action of a previous recommendation, wherein the action for the potential facility project is determined based on a result of the comparing.

Example 84. The method of example 83, wherein the actual operational cost of a comparable facility comprises a sum of operation costs of all facility items of the comparable facility.

Example 85. The method of example 84, wherein the comparing comprises normalizing one or more of the actual operational cost of the comparable facility and the value proposition for the corresponding action of the previous recommendation to compare a total actual operational cost of the comparable facility (i.e. a sum of operational costs of all facility items) to a total anticipated operational cost of the comparable facility (i.e., a sum of operational costs of all facility items with the value proposition integrated).

Example 86. The method of example 84, wherein the comparing comprises normalizing one or more of the actual operational cost of the comparable facility and the value proposition for the corresponding action of the previous recommendation to compare an actual operational cost of the corresponding comparable facility items to which pertains the implemented actions to the value proposition for performing the action of the previous recommendation.

Example 87. The method of example 54, wherein receiving the facility data for the target facility comprises receiving a digital representation of the target facility.

Example 88. The method of example 87, wherein the digital representation comprises map data of the target facility, the map data including plan data providing a layout of the facility and including the facility item data that includes a location of each facility item within the layout of the facility.

Example 89. The method of example 88, wherein the layout of the facility comprises a floor plan of a structure of the facility.

Example 90. The method of example 89, wherein the layout of the facility further comprises a reflected ceiling plan of the structure.

Example 91. The method of example 87, wherein the digital representation comprises the operational data of the target facility, the operational data providing historical operating conditions of the facility, including the one or more facility items.

Example 92. The method of example 87, further comprising providing a digital, three-dimensional (3D) visualization of the facility to a user, the visualization generated from the digital representation, the visualization to present or render to the user a layout of the facility, the one or more facility items, and operating conditions of the facility.

Example 93. The method of example 87, wherein receiving the facility data for the target facility comprises accessing the facilities data set.

Example 94. The method of example 87, wherein the one or more facility items include both operational facility items (i.e. operate to perform a function, e.g., HVAC, lighting,) and nonoperational facility items (i.e., do not operate, e.g., window, tile flooring, a staircase).

Example 95. The method of example 54, wherein the target facility comprises one or more structures and a site upon which the one or more structures are constructed.

Example 96. The method of example 54, wherein the item data for the one or more facility items further includes one or more specifications (i.e., equipment specifications) for at least the one or more facility items that comprise operation equipment, the one or more specifications provided by a manufacturer of each facility item to describe its physical and operational characteristics (i.e., how the facility item is designed or intended to perform/operate).

Example 97. The method of example 54, further comprising: generating a proposal for the facility, the proposal comprising a set of one or more recommendations.

Example 98. The method of example 54, further comprising: receiving approval of the recommendation from the target facility; and instructing performance or implementation of the action of the recommendation, according to the approval of the recommendation that was received from the target facility.

Example 99. The method of example 98, further comprising: collecting new outcome data following completion of the action of the recommendation; and updating the facilities data set to include the new outcome data.

Example 100. The method of example 99, wherein one or more of the action, the value proposition value, and the expenditure value is determined by providing the facility data for the target facility to an algorithm trained on or that considers the facility data of the plurality of comparable facilities.

Example 101. The method of example 100, further comprising: modifying the algorithm based on the new outcome data.

Example 102. The method of example 54, wherein the action of the recommendation comprises one or more of improving, upgrading, replacing, retrofitting, modifying, and maintaining the facility item to which the recommendation pertains.

Example 103. A system of facility management, comprising: a communication network interface to communicate over a network with a facility; one or more processors; a non-transitory memory having stored thereon instructions that, when executed by the one or more processors, cause the one or more processors to perform operations to enhance facility management to: receive facility data for a facility to undergo a facility project, the facility data including one or more of item data for facility items of the target facility that are relevant to the potential facility project, location data of each facility item within a layout of the target facility, and/or operational data for the facility; receive candidate component (or item) data for candidate components relevant to the facility project, the candidate components each having one or more meaningful similarities with one or more of the facility items; determine a value proposition value for performing or implementing an action of the facility project based on the facility data for the facility and the candidate component data, the action involving one or more of the facility items and one or more of the candidate components; receive confirmation of completion of the action at the facility; and create a token on a blockchain corresponding to the value proposition for the action. The value proposition may be one of an energy savings and an energy generation. The token may represent a quantity of the one of the energy savings and the energy generation.

Example 104. The system of Example 103, further comprising: a blockchain computing system to implement the blockchain.

Example 105. The system of Example 103, wherein the instructions further cause the one or more processors to perform operations to: collect outcome data following completion of the action project; and adjust the value proposition based on the outcome data.

Example 106. The system of Example 103, wherein the instructions further cause the one or more processors to perform operations to: access a facilities data set including comparable (or similar) facility data of a plurality of comparable facilities each having one or more meaningful similarities with the target facility, the comparable facility data including item data for facility items of the plurality of comparable facilities and operational data for the plurality of comparable facilities, wherein the value proposition is one of determined and adjusted based on the comparable facility data.

Example 107. The system of Example 106, wherein the comparable facility data further includes outcome data providing information pertaining to an outcome of a completed facility project at a comparable facility, wherein the value proposition value is further determined based on the outcome data.

Example 108. The system of Example 106, wherein the facilities data set includes one or more previous recommendations provided to one or more of the plurality of comparable facilities and operational data for the plurality of comparable facilities, wherein the value proposition is further determined based at least in part on comparing value propositions of the one or more previous recommendations to the operational data for one or more of the plurality of comparable facilities.

Example 109. The system of Example 108, wherein the operational data for the plurality of comparable facilities provides operating conditions that include one or more of an actual operational cost of the comparable facilities and data from which the actual operational cost of the comparable facilities can be derived, wherein the instructions further cause the one or more processors to perform operations to: compare the actual operational cost of a comparable facility to a value proposition value for a corresponding action of a previous recommendation, wherein the value proposition for the facility project is determined based on a result of the comparing.

Example 110. The system of Example 103, wherein the facility receives a service provided by a service provider in exchange for the token, the method further comprising: recording the exchange of the token for the service on the blockchain.

Example 111. The system of Example 103, wherein the instructions further cause the one or more processors to perform operations to: generate a recommendation for the facility, the recommendation comprising the action to be performed in relation to the one or more corresponding facility items and the value proposition for performing the action; transmit the proposal to the facility; receive approval of the recommendation; and instructing performance of the action, according to the approval of the recommendation.

Example 112. The system of Example 103, wherein the token comprises a smart contract.

Example 113. The system of Example 112, wherein the smart contract includes self-execution, according to pre-determined conditions, to effectuate one or more of: presale of future electricity; transfer the token to a different entity; transfer another token on the blockchain to a different entity; and schedule a future action.

Example 114. A computer implemented method of facility management, comprising: receiving facility data for a facility to undergo a facility project, the facility data including one or more of item data for facility items of the target facility that are relevant to the potential facility project, location data of each facility item within a layout of the target facility, and/or operational data for the facility; receiving candidate component (or item) data for candidate components relevant to the facility project, the candidate components each having one or more meaningful similarities with one or more of the facility items; determining a value proposition value for performing or implementing an action of the facility project based on the facility data for the facility and the candidate component data, the action involving one or more of the facility items and one or more of the candidate components; receiving confirmation of completion of the action at the facility; and creating a token on a blockchain corresponding to the value proposition for the action. The value proposition may be one of an energy savings and an energy generation. The token may represent a quantity of the one of the energy savings and the energy generation.

Example 115. The method of Example 114, further comprising: collecting outcome data following completion of the action project; and adjusting the value proposition based on the outcome data.

Example 116. The method of Example 114, further comprising: accessing a facilities data set including comparable (or otherwise similar) facility data of a plurality of comparable facilities each having one or more meaningful similarities with the target facility, the comparable facility data including item data for facility items of the plurality of comparable facilities and operational data for the plurality of comparable facilities, wherein the value proposition is one of determined and adjusted based on the comparable facility data.

Example 117. The method of Example 116, wherein the comparable facility data further includes outcome data providing information pertaining to an outcome of a completed facility project at a comparable facility, wherein the value proposition value is further determined based on the outcome data.

Example 118. The method of Example 116, wherein the facilities data set includes one or more previous recommendations provided to one or more of the plurality of comparable facilities and operational data for the plurality of comparable facilities, wherein the value proposition is further determined based at least in part on comparing value propositions of the one or more previous recommendations to the operational data for one or more of the plurality of comparable facilities.

Example 119. The method of Example 118, wherein the operational data for the plurality of comparable facilities provides operating conditions that include one or more of an actual operational cost of the comparable facilities and data from which the actual operational cost of the comparable facilities can be derived, the method further comprising: comparing the actual operational cost of a comparable facility to a value proposition value for a corresponding action of a previous recommendation, wherein the value proposition for the facility project is determined based on a result of the comparing.

Example 120. The method of Example 114, wherein the facility receives a service provided by a service provider in exchange for the token, the method further comprising: recording the exchange of the token for the service on the blockchain.

Example 121. The method of Example 114, further comprising: generating a recommendation for the facility, the recommendation comprising the action to be performed in relation to the one or more corresponding facility items and the value proposition for performing the action; transmitting the proposal to the facility; receiving approval of the recommendation; and instructing performance of the action, according to the approval of the recommendation.

Example 122. The method of Example 114, wherein the token comprises a smart contract.

Example 123. The method of Example 122, wherein the smart contract includes self-execution, according to pre-determined conditions, to effectuate one or more of: presale of future electricity; transfer the token to a different entity; transfer another token on the blockchain to a different entity; and schedule a future action.

Example 124. A computer implemented method of energy management, comprising: receiving facility data for a plurality of facilities, including target facility data for a target facility to undergo a facility project; determining a value proposition value for an action (e.g. performing or otherwise implementing) of the facility project based on the facility data for the target facility and candidate project data, wherein the value proposition comprises one of an energy savings and an energy generation; and creating a token on a blockchain corresponding to the value proposition for the action, the token representing a quantity of the one of the energy savings and the energy generation.

Example 125. The method of Example 124, wherein the facility data includes one or more of item data for facility items of the target facility that are relevant to the potential facility project, location data of each facility item within a layout of the target facility, and/or operational data for the target facility, wherein the project data includes candidate component data (e.g., item data) for candidate components relevant to the facility project and each having one or more meaningful similarities with one or more of the facility items, and wherein the action involves one or more of the facility items and one or more of the candidate components.

Example 126. The method of Example 124, further comprising: transferring the token to another facility of the plurality of facilities in exchange for one or more of: energy to be generated in the future that can power the target facility; one or more facility items for the target facility; a service to be performed for the target facility; one or more products for the target facility; and recording the exchange to blockchain.

Example 127. The method of Example 124, wherein the token comprises a smart contract.

Example 128. The method of Example 127, wherein the smart contract includes self-execution, according to pre-determined conditions, to effectuate one or more of: presale of future energy; transfer the token to a different entity; transfer another token on the blockchain to a different entity; and schedule a future action.

Example 129. A system of energy management, comprising: a communication network interface to communicate over a network with a plurality of facilities; one or more processors; a non-transitory memory having stored thereon instructions that, when executed by the one or more processors, cause the one or more processors to perform operations to: receive facility data for the plurality of facilities, including a target facility to undergo a facility project; determine a value proposition value for an action of the facility project based on the facility data for the target facility and candidate project data, wherein the value proposition comprises one of an energy savings and an energy generation; and create a token on a blockchain corresponding to the value proposition for the action and including a quantity of the one of the energy savings and the energy generation.

Example 130. The system of Example 129, wherein the facility data includes one or more of item data for facility items of the target facility that are relevant to the potential facility project, location data of each facility item within a layout of the target facility, and/or operational data for the target facility, wherein the project data includes candidate component data (e.g., item data) for candidate components relevant to the facility project and having one or more meaningful similarities with one or more of the facility items, and wherein the action involves one or more of the facility items and one or more of the candidate components.

Example 131. The system of Example 129, wherein the instructions further cause the one or more processors to perform operations to: transfer the token to another facility of the plurality of facilities in exchange for one or more of: energy to be generated in the future that can power the target facility; one or more facility items for the target facility; a service to be performed for the target facility; one or more products for the target facility; and record the exchange to blockchain.

Example 132. The system of Example 129, wherein the token comprises a smart contract.

Example 133. The system of Example 132, wherein the smart contract includes self-execution, according to pre-determined conditions, to effectuate one or more of: presale of future energy; transfer the token to a different entity; transfer another token on the blockchain to a different entity; and schedule a future action.

It will be obvious to those having skill in the art that many changes may be made to the details of the above-described embodiments without departing from the underlying principles of the invention.

1. A system of facility management comprising:
a communication network interface to communicate over a network with a facility;
one or more processors;
a non-transitory memory having stored thereon instructions that, when executed by the one or more processors, cause the one or more processors to perform operations to enhance facility management to:
receive, via the communication network, facility data for a target facility of a potential facility project, the facility data including item data for facility items of the target facility that are relevant to the potential facility project;
receive, via the communication network, candidate component data for candidate components relevant to the potential facility project, the candidate components each having one or more meaningful similarities with one or more of the facility items;
access a facilities data set including comparable facility data of a plurality of comparable facilities each having one or more meaningful similarities with the target facility, the comparable facility data including item data for facility items of the plurality of comparable facilities;
determine an action for the potential facility project in relation to one or more of the facility items and one or more of the candidate components;
determine a value proposition value for the action based on the facility data for the target facility, the facility data of the plurality of comparable facilities, and the candidate component data;
determine an expenditure value for the action based on the facility data for the target facility, the facility data of the plurality of comparable facilities, and the candidate component data;
provide, via the communication network, a recommendation for the target facility, the recommendation including the action and one or more of: the one or more facility items, the one or more candidate components, the value proposition value, and the expenditure value.

2. The system of claim 1, wherein the comparable facility data further includes outcome data providing information pertaining to an outcome of a completed facility project at a comparable facility,
wherein the value proposition value is further determined based on the outcome data.

3. The system of claim 1, wherein the value proposition value is determined by providing the facility data for the target facility to an algorithm trained on the facility data of the plurality of comparable facilities.

4. The system of claim 3, wherein the algorithm comprises a neural network.

5. The system of claim 3, wherein the instructions further cause the one or more processors to perform operations to:
collect new outcome data following completion of the potential facility project; and
modify the algorithm based on the new outcome data.

6. The system of claim 1, wherein the expenditure value is determined by providing the facility data for the target facility to an algorithm trained on the facility data of the plurality of comparable facilities.

7. The system of claim 1, wherein the action is determined by providing the facility data for the target facility to an algorithm trained on the facility data of the plurality of comparable facilities.

8. The system of claim 1, wherein the instructions further cause the one or more processors to perform operations to:
update the facilities data set to include the facility data of the target facility for consideration in future recommendations.

9. The system of claim 1, wherein the instructions further cause the one or more processors to perform operations to:
receive approval of the recommendation for the target facility; and
instruct the action of the recommendation, according to the approval of the recommendation that was received for the target facility.

10. The system of claim 9, wherein the instructions further cause the one or more processors to perform operations to:
collect new outcome data following completion of the action of the recommendation; and
update the facilities data set to include the new outcome data.

11. The system of claim 10, wherein one or more of the action, the value proposition value, and the expenditure value is determined by providing the facility data for the target facility to a respective algorithm trained on the facility data of the plurality of comparable facilities.

12. The system of claim 11, wherein the instructions further cause the one or more processors to perform operations to:
alter the algorithm based on the new outcome data.

13. A computer implemented method of providing a facility recommendation, comprising:
receiving facility data for a target facility of a potential facility project, the facility data including item data for facility items of the target facility that are relevant to the potential facility project;
receiving candidate component data for candidate components relevant to the potential facility project, the candidate components each having one or more meaningful similarities with one or more of the facility items;
accessing a facilities data set including comparable facility data of a plurality of comparable facilities each having one or more meaningful similarities with the target facility, the comparable facility data including item data for facility items of the plurality of comparable facilities;
determining an action for the potential facility project in relation to one or more of the facility items and one or more of the candidate components;
determining a value proposition value for the action based on the facility data for the target facility, the facility data of the plurality of comparable facilities, and the candidate component data;
determining an expenditure value for the action based on the facility data for the target facility, the facility data of the plurality of comparable facilities, and the candidate component data;
calculating a return on investment based on the value proposition value and the expenditure value;
providing a recommendation for the target facility, the recommendation including the action, the one or more facility items, the one or more candidate components, and one or more of the value proposition value, the expenditure value, and the return on investment.

14. The method of claim 13, further comprising:
updating the facilities data set to include the facility data of the target facility for consideration in future recommendations.

15. The method of claim 13, wherein the facilities data set includes one or more previous recommendations provided to one or more of the plurality of comparable facilities and operational data for the plurality of comparable facilities, wherein the value proposition value is further determined based at least in part on comparing value propositions of the one or more previous recommendations to the operational data for one or more of the plurality of comparable facilities.

16. The method of claim 15, wherein the operational data for the plurality of comparable facilities provides operating conditions that include one or more of an actual operational cost of the comparable facilities and data from which the actual operational cost of the comparable facilities can be derived, the method further comprising:
comparing the actual operational cost of a comparable facility to a value proposition value for a corresponding action of a previous recommendation,
wherein the action for the potential facility project is determined based on a result of the comparing.

17. The method of claim 16, wherein the comparing comprises normalizing one or more of the actual operational cost of the comparable facility and the value proposition for the corresponding action of the previous recommendation to compare a total actual operational cost of the comparable facility to a total anticipated operational cost of the comparable facility.

18. The method of claim of claim 13, wherein receiving the facility data for the target facility comprises receiving a digital representation of the target facility.

19. The method of example 13, wherein the target facility comprises one or more structures and a site upon which the one or more structures are constructed.

20. The method of claim 13, wherein the item data for the one or more facility items further includes one or more specifications (i.e., equipment specifications) for at least the one or more facility items that comprise operation equipment, the one or more specifications provided by a manufacturer of each facility item to describe its physical and operational characteristics (i.e., how the facility item is designed or intended to perform/operate).

21. The method of claim 13, further comprising: generating a proposal for the facility, the proposal comprising a set of one or more recommendations.

22. The method of claim 13, further comprising:
receiving approval of the recommendation from the target facility; and
instructing performance or implementation of the action of the recommendation, according to the approval of the recommendation that was received from the target facility.

23. The method of claim 13, wherein the action of the recommendation comprises one or more of improving, upgrading, replacing, retrofitting, modifying, and maintaining the facility item to which the recommendation pertains.
